(19) United States
(12) Patent Application Publication
(10) Pub. No.: US 2023/0018569 A1
(43) Pub. Date: Jan. 19, 2023

(54) SYSTEM AND METHOD FOR GENERATING ACTUAL POINT OF SALE VEHICLE SERVICE COST TRENDS

(71) Applicant: NURSE'S EMISSION TESTING & REPAIR FACILITY INC., Peterborough, ONTARIO (CA)

(72) Inventor: Robert Douglas Smithson NURSE, Peterborough, Ontario (CA)

(21) Appl. No.: 17/781,974

(22) PCT Filed: Dec. 6, 2019
(86) PCT No.: PCT/CA2019/051761

§ 371 Date: Jun. 2, 2022

(51) Int. Cl. G06Q 30/02; G06Q 50/30; G06Q 30/04; G06Q 10/00

(52) U.S. Cl. CPC G06Q 30/0284; G06Q 50/30; G06Q 30/04; G06Q 10/20

(57) ABSTRACT

A method for providing a service cost trend of a vehicle as a function of a parameter. A trend generator accepts data, generated at a POS processor in a facility, without transcribing information, of an actual service activity cost performed there; stores the data according to its unique vehicle identifier and parameter value, determines a parameter range apportioned into intervals, orders accumulated data associated with the identifier whose parameter lies within the range by parameter value, divides the data into interval sets and extracts an attribute from the data in each set. A system may include a service facility and a trend generator having a receiver, a sorter, a trend generator and a transmitter to perform the method.

### RELATED APPLICATIONS

Not applicable.

### TECHNICAL FIELD

The present disclosure relates to automotive maintenance, diagnostic and/or repair management systems and in particular to a method and system for accessing actual point of sale vehicle service cost data generated by such systems to generate trends thereof as a function of a trend parameter, such as date, time and/or accumulated mileage on individual vehicles.

### BACKGROUND

The term “automotive industry” is generally understood to encompass a wide variety of businesses involved in the design, development, marketing and selling of motor vehicles and/or components thereof, including original equipment manufacturers (OEMs), but does not generally extend to after-market industries, such as fuel refilling stations and/or automobile repair facilities, devoted to the maintenance and/or operation (“service”) of such vehicles after delivery to an end-user. It will be appreciated that the end-user will typically be an individual, who may be the owner or the lessee of the vehicle, or a family member or acquaintance of the owner or lessee or, if the owner or lessee is a corporation, an officer, employee or agent of the owner or lessee. It will also be appreciated that additional arrangements may be conceived of, by which the end-user may be other than one of the possibilities listed above. For reasons of simplicity of discussion only, all such entities will be collectively referred to herein as the “end-user”.

The automotive industry is recognized as one of the world's largest economic sectors by revenue. At its forefront are a number of vehicle manufacturers, most of whom typically maintain a network of associated vehicle dealerships by which new (and in some non-limiting examples, pre-owned) vehicles are marketed, demonstrated and sold, as well as a long chain of supporting businesses, who provide components used in manufacturing and/or service of the vehicles, as well as services related to, without limitation, marketing, financing and legal services associated with the sale, lease and/or other such transaction involving such vehicles. For reasons of simplicity of discussion only, all such transactions will be collectively referred to herein as “obtaining” the vehicle.

In order to sustain this industrial behemoth, virtually every initiative of the manufacturers, their dealer networks and the businesses supporting them, is directed toward encouraging end-users to obtain new vehicles year after year. By way of non-limiting example, a variety of payment and financing mechanisms have been created to lower the up-front cost and monthly payment obligations to obtain a new vehicle, and to also reduce the time period before the end-user would return to the dealership to begin negotiations to obtain a new vehicle.

Even the parts, service and pre-owned vehicle divisions of a new car dealership, while in some cases, profit centres of their own, may also be considered to be initiatives directed to encourage the end-user to return to the dealership, to be enticed with the prospect of replacing, supplementing and/or upgrading an older vehicle by obtaining a brand-new vehicle. Such initiatives include, without limitation, entitlement under a dealership customer loyalty program. However, access to such customer loyalty program may be limited at a manufacturer or dealership (or even division thereof) level, which may reduce the ability of the end-user to access such entitlements, or for after-market industries from participating in such programs.

With the foregoing in mind, there is very little incentive for the automotive industry to provide, or at least to facilitate, easy access, by the end-user, of accurate information regarding the actual point of sale cost of servicing any given vehicle at any given stage while in the end-user's possession and how such costs is trending as a function of time.

Rather, the automotive industry assiduously fosters a vague notion that the vehicle, as it ages and/or accumulates mileage, will progressively and precipitously become more and more expensive to service, all in an effort to encourage the end-user to avoid such purported escalating costs, by returning to the dealership to obtain a new vehicle.

For example, despite the ready availability of electronic invoicing for all manner of products and services, the automotive industry (and indeed, the after-market service and fueling facilities associated with vehicles sold by it) remains one of the few industries that routinely may provide invoices in printed (often over many dense pages) form, without any historical summary of accumulated expenses, even though sophisticated online resources have been developed to facilitate the maintaining of sufficient inventory, ordering, delivery and internal invoicing of parts for repair facilities to service the vehicle.

Further, conventional electronic bookkeeping and invoicing software packages that typically provide the option for electronic invoicing, such as, without limitation, Quickbooks and/or SimplyAccounting, are generally not well-suited for use in the automotive industry or for after-market service facilities and, as a result, have not enjoyed significant market penetration.

As a result of the foregoing, the end-user is typically unaware of the exact costs that it has incurred in the service of its vehicle, much less how these costs trend as a function of the a trend parameter, such as, without limitation, date, time and/or accumulated mileage since it obtained the vehicle.

Even if the end-user wished to access such information, in order to do so, the end-user would be called upon to accumulate, analyze and extract relevant cost information from a vast sheaf of such printed invoices, in a largely manual and error-prone transcription process. Indeed, even if an electronic invoice is generated and provided to the end-user, such electronic invoice is typically an electronically-transmitted representation of a printed invoice (such as an e-mail enclosing a portable document format (PDF) of a paper invoice) that is not easily searchable to obtain the underlying invoice data without some sort of manual or automated transcription.

Were such efforts actually undertaken, in many cases, the end-user would be surprised at its actual costs of servicing the vehicle since it was obtained, especially when expressed as a trend function of a trend parameter, such as, without limitation, date, time and/or accumulated mileage. Typically, the costs, and the slope of any upward trend, may be lower than the end-user has been led to expect. In some non-limiting examples, the trend may raise and fall at approximately 100,000 km intervals, usually related to an expected time when brakes and/or tires are to be replaced.

There are a few, usually after-market services, that attempt to bridge such an information gap, by providing figure of merit estimates of service costs of certain vehicles, such as printed used vehicle guides. However, by and large, such services rely on inaccurate estimates of typical costs, such as parts costs, average shop rates and “standard” repair times, rather than the actual costs, incurred at the point of sale of maintenance services, by the particular end-user (and/or any predecessor) for the particular vehicle. Such services necessarily provide an average value, representative of the type, year and/or model of vehicle, as well as a (usually large) geographic region and a wide variety of levels of service provided. For this reason, any such information is often expressed in terms of a (fairly wide) range, within which there is no basis for identifying where in the range the end-user's particular vehicle falls. Additionally, such attempts often involve, at some point (and usually several points) in the process, manual transcription of data points into an electronic database, which can incur transcription errors that get propagated and multiplied and/or is prone to malicious provision of false information. Further, such services do not tend to provide cost trends as a function of time.

Additionally, there are a few, again usually after-market services, that attempt to document the damage and repair history of individual vehicles, such as vehicle repair history reports. However, such reports typically are focused mainly on the incidence of damage, and the repairs occasioned to remediate such damage, so as to alert the reader to undocumented problems when seeking to obtain the vehicle on the secondary market, as opposed to providing a trend of the cost of servicing such vehicle as a function of a trend parameter, such as, without limitation, date, time and/or accumulated mileage. To this end, such reports tend not to provide an estimate of the service costs, much less the actual service costs incurred at the point of sale of a maintenance facility and/or trends thereof as a function of a trend parameter, such as, without limitation, date, time and/or accumulated mileage.

### BRIEF DESCRIPTION OF THE DRAWINGS

Examples of the present disclosure will now be described by reference to the following figures, in which identical reference numerals in different figures indicate identical elements and in which:

FIG. 1 is an example simplified block diagram of a system for generating actual point of sale vehicle service cost trends, according to the present disclosure;

FIG. 2 is an example data structure for POS electronic data for use in the system of FIG. 1;

FIG. 3 is an example data structure for a vehicle record in the example POS electronic data of FIG. 2;

FIG. 4 is an example data structure for a service activity record in the example POS electronic data of FIG. 2;

FIG. 5 is a simplified block diagram of a trend generator in the system of FIG. 1;

FIG. 6 is an example data structure for a report request for use in the system of FIG. 1;

FIG. 7 is an example data structure for a report for use in the system of FIG. 1;

FIG. 8 is an example of a trend report according to the present disclosure;

FIG. 9 is an example of a comparison report according to the present disclosure;

FIG. 10 is an example of a service cost and history report according to the present disclosure;

FIG. 11 is an example of a business use category report according to the present disclosure;

FIG. 12 is an example of a customer loyalty program (CLP) report according to the present disclosure;

FIG. 13 is an example data structure for a CLP entitlement datum for use in the system of FIG. 1;

FIG. 14 is an example data structure for a CLP reward record in the example of a CLP entitlement datum of FIG. 13; and

FIG. 15 is an example flow chart showing method actions according to the present disclosure.

In the present disclosure, for purposes of explanation and not limitation, specific details are set forth in order to provide a thorough understanding of the present disclosure, including, without limitation, particular architectures, interfaces and/or techniques. In some instances, detailed descriptions of well-known systems, technologies, components, devices, circuits, methods and applications are omitted so as not to obscure the description of the present disclosure with unnecessary detail.

Further, it will be appreciated that block diagrams reproduced herein can represent conceptual views of illustrative components embodying the principles of the technology.

Accordingly, the system and method components have been represented where appropriate by conventional symbols in the drawings, showing only those specific details that are pertinent to understanding the examples of the present disclosure, so as not to obscure the disclosure with details that will be readily apparent to those of ordinary skill in the art having the benefit of the description herein.

Any feature or action shown in dashed outline may in some non-limiting examples be considered as optional.

### SUMMARY

It is an object of the present disclosure to obviate or mitigate at least one disadvantage of the prior art.

The present disclosure discloses a system and method for providing actual point of sale vehicle service cost trends as a function of a trend parameter, such as, without limitation, date, time and/or accumulated mileage.

It will be appreciated that while the present disclosure discusses the system and/or method in terms of the service of a vehicle in the automotive industry, such system and/or method should not be considered as being limited solely to an automotive vehicle. Rather, the vehicles to which such system and/or method may be applicable, may, without limitation, include land vehicles, such as, without limitation, motor vehicles (including without limitation, automobiles, trucks, buses, all-terrain vehicles, snowmobiles, trailers and/or motorcycles), railed vehicles (including without limitation, trains and/or trams), unpowered and/or e-powered vehicles (such as, without limitation, bicycles, scooters and/or self-balancing transporters), watercraft (including without limitation, ships, boats and/or personal watercraft), amphibious vehicles (including without limitation, screw-propelled vehicles and/or hovercraft), aircraft (including without limitation, airplanes, helicopters and/or ultra-light aircraft) and/or spacecraft. For reasons of simplicity of discussion only, all such vehicles will be collectively referred to herein as the “vehicle”.

According to a broad aspect of the present disclosure, there is disclosed a trend generator for providing at least one trend of service costs, of a vehicle having a unique identifier, as a function of a parameter, comprising: a receiver for accepting, at least one of: a report request from an end-user of the vehicle and at least one datum generated at a point of sale in a service facility, from a processor in the facility in a manner devoid of transcription of information contained therein, the at least one datum comprising an actual cost of a service activity performed at the facility; a sorter for forwarding the request and for storing the at least one datum in association with the identifier and a value of the parameter; a trend engine for: determining from the request that the at least one trend is to be provided for all data associated with the identifier, for a range of the parameter, apportioned into at least one interval; ordering all data having a value of the parameter that lies within the range, that was previously accumulated in association with the identifier, according to the value of the parameter; dividing the ordered data into sets corresponding to successive intervals within the range, based on the value of the parameter associated with each datum thereof; and extracting an attribute from the data in each set to create a trend report responsive to the request; and a transmitter for providing the report for access by the end-user.

In an example, the parameter can be at least one of: date, time and accumulated mileage.

In an example, the receiver can be adapted to accept at least one transcribed datum comprising a transcription of an actual cost of a service activity performed at at least one of: the facility and another facility, and the sorter is adapted to store the at least one transcribed datum. In an example, the trend generator can be adapted to confirm that security measures have been taken to preclude provision of false information in at least one transcribed datum. In an example, the security measures can be provided by the receiver when receiving the at least one transcribed datum. In an example, the security measures can be provided when the transcription is performed.

In an example, the receiver can receive the request from at least one of: a processor in the facility, a processor of the end-user, the end-user, another trend generator, and a government vehicle registry.

In an example, the receiver can be adapted to accept the at least one datum from a government vehicle registry.

In an example, the trend generator can further comprise a data repository for maintaining the at least one datum stored by the sorter and permitting access thereto by the trend engine.

In an example, the transmitter can provide the report to the end-user at at least one of: a processor in the facility a processor of the end-user, the end-user, and a government vehicle registry.

In an example, the at least one datum can comprise a vehicle datum comprising the identifier and at least one service activity datum.

In an example, the vehicle datum can comprise at least one of: a vehicle identification number (VIN) of the vehicle, a date, a time, a mileage, a government registration identifier, information describing the vehicle, and information describing the end-user.

In an example, the at least one service activity datum can comprise at least one of: a vehicle identification number (VIN) of the vehicle, a date, a time, a mileage, information describing the service activity and information describing a service cost of performing the service activity.

In an example, the range can begin at a value of the parameter at an initial event that is at least one of: when the end-user obtained the vehicle, when a previous end-user of the vehicle obtained the vehicle, a beginning of a calendar year, a beginning of a fiscal year of the end-user, an initial service activity performed on the vehicle, a mileage threshold of the vehicle, and a significant event of the end-user.

In an example, the parameter can be a date and the interval can be at least one of: a range of consecutive years, a year, a half-year, a quarter, a trimester and a month. In an example, the parameter can be an accumulated mileage and the interval can be at least one of: 100,000 miles, 50,000 miles, 20,000 miles, 10,000 miles, 5,000 miles, 2,000 miles, 1,000 miles, 500 miles, 250 miles, 100 miles, 50 miles, 200,000 km, 100,000 km, 50,000 km, 20,000 km, 10,000 km, 5,000 km, 2,000 km, 1,000 km, 500 km, 250 km and 100 km.

In an example, the attribute extracted can be at least one of: a total service cost, an average service cost, a median service cost, a number of service appointments, a number of service activities, a category of service activities, a type of service activity, a total duration of service activities, an average duration of service activities, a median duration of service activities, a number of days in a service facility, a duration of a service activities and a number of unit hours incurred in a service activity of the data in the set.

In an example, the service facility can be at least one of: an automotive repair facility, a fuel refilling station, a car dealership, a service department of a dealership, a parts department of a dealership, a government vehicle registry, and another end-user.

In an example, the trend generator can further comprise a comparator for receiving a comparison report request, juxtaposing at least one of the trend and the ordered data against an estimate of vehicle service costs for at least one interval within the range to create a comparison report responsive thereto.

In an example, the trend generator can further comprise a historian for receiving a history report request and listing at least a subset of all data associated with the vehicle to create a history report responsive thereto.

In an example, the trend generator can further comprise a calculator for receiving a use category report request and allocating the data associated with the vehicle within the range to one of a plurality of use categories, based at least one use datum, each identifying a subset of the range and allocated to one of the categories to create a use category report responsive thereto. In an example, the receiver can accept the use data from at least one of: a processor of the end-user and the end-user.

In an example, the trend generator can further comprise a customer loyalty administrator for accumulating the data associated with at least one vehicle of the end-user in the range and awarding at least one entitlement under a customer loyalty program (CLP) conditioned on at least one of: the vehicle and the end-user, when at least one threshold of the CLP is exceeded by a feature of the accumulated data. In an example, the feature can be at least one of: the total service cost, a number of service activities and a type of service activity of the accumulated data in the range.

According to a broad aspect of the present disclosure, there is disclosed a system for providing at least one trend of service costs, of a vehicle having a unique identifier, as a function of a parameter, comprising: a service facility having a processor, for performing a service activity on the vehicle and communicating at least one datum comprising an actual cost of the service activity, generated by the processor at a point of sale in the facility, in a manner devoid of transcription of information contained therein; a trend generator comprising: a receiver for accepting, at least one of: a report request from an end-user of the vehicle and the at least one datum; a sorter for forwarding the request and for storing the at least one datum in association with the identifier and a value of the parameter; a trend engine for: determining from the request that the at least one trend is to be provided for all data associated with the identifier, for a range of the parameter, apportioned into at least one interval; ordering all data having a value of the parameter that lies within the range, that was previously accumulated in association with the identifier, according to the value of the parameter; dividing the ordered data into sets corresponding to successive intervals within the range, based on the value of the parameter associated with each datum thereof; and exacting an attribute from the data in each set to create a trend report responsive to the request; and a transmitter for providing the report for access by the end-user.

According to a broad aspect, there is disclosed a method for providing at least one trend of service costs, of a vehicle having a unique identifier, as a function of a parameter, comprising: accepting at least one datum generated at a point of sale in a service facility, from a processor in the facility in a manner devoid of transcription of information contained therein, the at least one datum comprising an actual cost of a service activity performed at the facility; storing the at least one datum in association with the identifier and a value of the parameter; receiving a report request from an end-user of the vehicle; determining from the request that the at least one trend is to be provided for all data associated with the identifier, for a range of the parameter, apportioned into at least one interval; ordering all data having a value of the parameter that lies within the range, that was previously accumulated in association with the identifier, according to the value of the parameter; dividing the ordered data into sets corresponding to successive intervals within the range, based on the value of the parameter associated with each datum thereof; and extracting an attribute from the data in each set to create a trend report responsive to the request; and transmitting the report for access by the end-user.

In an example, the parameter can be at least one of: date, time and accumulated mileage.

In an example, the method can further comprise actions of: accepting at least one transcribed datum comprising a transcription of an actual cost of a service activity performed at at least one of: the facility and another facility and storing the at least one transcribed datum. In an example, the method can further comprise: taking security measures to preclude provision of false information in at least one transcribed datum. In an example, the security measures can be provided when receiving the at least one transcribed datum. In an example, the security measures can be provided when the transcription is performed.

In an example, the method can be performed by a trend generator and the request can be received from at least one of: a processor in the facility, a processor of the end-user, the end-user, another trend generator, and a government vehicle registry.

In an example, the at least one datum can be accepted from a government vehicle registry.

In an example, the report can be provided to the end-user at at least one of: a processor in the facility a processor of the end-user, the end-user, and a government vehicle registry.

In an example, the at least one datum can comprise a vehicle datum comprising the identifier and at least one service activity datum.

In an example, the vehicle datum can comprise at least one of: a vehicle identification number (VIN) of the vehicle, a date, a time, a mileage, a government registration identifier, information describing the vehicle, and information describing the end-user.

In an example, the at least one service activity datum can comprise at least one of: a vehicle identification number (VIN) of the vehicle, a date, a time, a mileage, information describing the service activity and information describing a service cost of performing the service activity.

In an example, the range can begin at a value of the parameter at an initial event that is at least one of: when the end-user obtained the vehicle, when a previous end-user of the vehicle obtained the vehicle, a beginning of a calendar year, a beginning of a fiscal year of the end-user, an initial service activity performed on the vehicle, a mileage threshold of the vehicle, and a significant event of the end-user.

In an example, the parameter can be a date and the interval can be at least one of: a range of consecutive years, a year, a half-year, a quarter, a trimester and a month. In an example, the parameter can be an accumulated mileage and the interval can be at least one of: 100,000 miles, 50,000 miles, 20,000 miles, 10,000 miles, 5,000 miles, 2,000 miles, 1,000 miles, 500 miles, 250 miles, 100 miles, 50 miles, 200,000 km, 100,000 km, 50,000 km, 20,000 km, 10,000 km, 5,000 km, 2,000 km, 1,000 km, 500 km, 250 km and 100 km.

In an example, the attribute extracted can be at least one of: a total service cost, an average service cost, a median service cost, a number of service appointments, a number of service activities, a category of service activities, a type of service activity, a total duration of service activities, an average duration of service activities, a median duration of service activities, a number of days in a service facility, a duration of a service activities and a number of unit hours incurred in a service activity of the data in the set.

In an example, the service facility can be at least one of: an automotive repair facility, a fuel refilling station, a car dealership, a service department of a dealership, a parts department of a dealership, a government vehicle registry, and another end-user.

In an example, the action of receiving can comprise actions of: receiving a comparison report request, juxtaposing at least one of the trend and the ordered data against an estimate of vehicle service costs for at least one interval within the range and creating a comparison report responsive thereto.

In an example, the action of receiving can comprise actions of: receiving a history report request, listing at least a subset of all data associated with the vehicle and creating a history report responsive thereto.

In an example, the action of receiving can comprise actions of: obtaining at least one use datum, each identifying a subset of the range, receiving a use category report request and allocating the data associated with the vehicle within the range to one of a plurality of use categories, based on the use data, allocating each at least one use datum to one of the categories and creating a use category report responsive thereto. In an example, the use data can be obtained from at least one of: a processor of the end-user and the end-user.

In an example, the action of receiving can comprise: accumulating the data associated with at least one vehicle of the end-user in the range and awarding at least one entitlement under a customer loyalty program (CLP) conditioned on at least one of: the vehicle and the end-user, when at least one threshold of the CLP is exceeded by a feature of the accumulated data. In an example, the feature can be at least one of: the total service cost, a number of service activities and a type of service activity of the accumulated data in the range.

According to a broad aspect, there is disclosed a trend generator comprising: a processor; a non-transitory memory for storing instructions that, when executed by the processor, cause the trend generator to provide at least one trend of service costs, of a vehicle having a unique identifier, as a function of a parameter, by: accepting at least one datum generated at a point of sale in a service facility, from a processor in the facility in a manner devoid of transcription of information contained therein, the at least one datum comprising an actual cost of a service activity performed at the facility; storing the at least one datum in association with the identifier and a value of the parameter; receiving a report request from an end-user of the vehicle; determining from the request that the at least one trend is to be provided for all data associated with the identifier, for a range of the parameter, apportioned into at least one interval; ordering all data having a value of the parameter that lies within the range, that was previously accumulated in association with the identifier, according to the value of the parameter; dividing the ordered data into sets corresponding to successive intervals within the range, based on the value of the parameter associated with each datum thereof; and extracting an attribute from the data in each set to create a trend report responsive to the request; and transmitting the report for access by the end-user.

In an example, the parameter can be at least one of: date, time and accumulated mileage.

In an example, the instructions can further cause the trend generator to provide the trend by: accepting at least one transcribed datum comprising a transcription of an actual cost of a service activity performed at at least one of: the facility and another facility and storing the at least one transcribed datum. In an example, the instructions can further cause the trend generator to provide the trend by taking security measures to preclude provision of false information in at least one transcribed datum. In an example, the security measures can be provided when receiving the at least one transcribed datum. In an example, the security measures can be provided when the transcription is performed.

In an example, the request can be received from at least one of: a processor in the facility, a processor of the end-user, the end-user, another trend generator, and a government vehicle registry.

In an example, the at least one datum can be accepted from a government vehicle registry.

In an example, the report can be provided to the end-user at at least one of: a processor in the facility a processor of the end-user, the end-user, and a government vehicle registry.

In an example, the at least one datum can comprise a vehicle datum comprising the identifier and at least one service activity datum.

In an example, the vehicle datum can comprise at least one of: a vehicle identification number (VIN) of the vehicle, a date, a time, a mileage, a government registration identifier, information describing the vehicle, and information describing the end-user.

In an example, the at least one service activity datum can comprise at least one of: a vehicle identification number (VIN) of the vehicle, a date, a time, a mileage, information describing the service activity and information describing a service cost of performing the service activity.

In an example, the range can begin at a value of the parameter at an initial event that is at least one of: when the end-user obtained the vehicle, when a previous end-user of the vehicle obtained the vehicle, a beginning of a calendar year, a beginning of a fiscal year of the end-user, an initial service activity performed on the vehicle, a mileage threshold of the vehicle, and a significant event of the end-user.

In an example, the parameter can be a date and the interval can be at least one of: a range of consecutive years, a year, a half-year, a quarter, a trimester and a month. In an example, the parameter can be an accumulated mileage and the interval can be at least one of: 100,000 miles, 50,000 miles, 20,000 miles, 10,000 miles, 5,000 miles, 2,000 miles, 1,000 miles, 500 miles, 250 miles, 100 miles, 50 miles, 200,000 km, 100,000 km, 50,000 km, 20,000 km, 10,000 km, 5,000 km, 2,000 km, 1,000 km, 500 km, 250 km and 100 km.

In an example, the attribute extracted can be at least one of: a total service cost, an average service cost, a median service cost, a number of service appointments, a number of service activities, a category of service activities, a type of service activity, a total duration of service activities, an average duration of service activities, a median duration of service activities, a number of days in a service facility, a duration of a service activities and a number of unit hours incurred in a service activity of the data in the set.

In an example, the service facility can be at least one of: an automotive repair facility, a fuel refilling station, a car dealership, a service department of a dealership, a parts department of a dealership, a government vehicle registry, and another end-user.

In an example, the action of receiving can comprise actions of: receiving a comparison report request, juxtaposing at least one of the trend and the ordered data against an estimate of vehicle service costs for at least one interval within the range and creating a comparison report responsive thereto.

In an example, the action of receiving can comprise actions of: receiving a history report request, listing at least a subset of all data associated with the vehicle and creating a history report responsive thereto.

In an example, the action of receiving can comprise actions of: obtaining at least one use datum, each identifying a subset of the range, receiving a use category report request and allocating the data associated with the vehicle within the range to one of a plurality of use categories, based on the use data, allocating each at least one use datum to one of the categories and creating a use category report responsive thereto. In an example, the use data can be obtained from at least one of: a processor of the end-user and the end-user.

In an example, the action of receiving can comprise: accumulating the data associated with at least one vehicle of the end-user in the range and awarding at least one entitlement under a customer loyalty program (CLP) conditioned on at least one of: the vehicle and the end-user, when at least one threshold of the CLP is exceeded by a feature of the accumulated data. In an example, the feature can be at least one of: the total service cost, a number of service activities and a type of service activity of the accumulated data in the range.

According to a broad aspect there is disclosed a computer-readable medium operatively coupled to a processor operatively coupled to a trend generator for providing at least one trend of service costs, of a vehicle having a unique identifier, as a function of a parameter, the medium having stored thereon, computer-readable and computer-executable instructions which, when executed by the processor, cause the processor to perform actions of: accepting at least one datum generated at a point of sale in a service facility, from a processor in the facility in a manner devoid of transcription of information contained therein, the at least one datum comprising an actual cost of a service activity performed at the facility; storing the at least one datum in association with the identifier and a value of the parameter; receiving a report request from an end-user of the vehicle; determining from the request that the at least one trend is to be provided for all data associated with the identifier, for a range of the parameter, apportioned into at least one interval; ordering data having a value of the parameter that lies within the range, that was previously accumulated in association with the identifier, according to the value of the parameter; dividing the ordered data into sets corresponding to successive intervals within the range, based on the value of the parameter associated with each datum thereof; and extracting an attribute from the data in each set to create a trend report responsive to the request; and transmitting the report for access by the end-user.

In an example, the parameter can be at least one of: date, time and accumulated mileage.

In an example, the instructions can further cause the processor to perform actions of: accepting at least one transcribed datum comprising a transcription of an actual cost of a service activity performed at at least one of: the facility and another facility and storing the at least one transcribed datum. In an example, the instructions can further cause the processor to perform actions of taking security measures to preclude provision of false information in at least one transcribed datum. In an example, the security measures can be provided when receiving the at least one transcribed datum. In an example, the security measures can be provided when the transcription is performed.

In an example, the request can be received from at least one of: a processor in the facility, a processor of the end-user, the end-user, another trend generator, and a government vehicle registry.

In an example, the at least one datum can be accepted from a government vehicle registry.

In an example, the report can be provided to the end-user at at least one of: a processor in the facility a processor of the end-user, the end-user, and a government vehicle registry.

In an example, the at least one datum can comprise a vehicle datum comprising the identifier and at least one service activity datum.

In an example, the vehicle datum can comprise at least one of: a vehicle identification number (VIN) of the vehicle, a date, a time, a mileage, a government registration identifier, information describing the vehicle, and information describing the end-user.

In an example, the at least one service activity datum can comprise at least one of: a vehicle identification number (VIN) of the vehicle, a date, a time, a mileage, information describing the service activity and information describing a service cost of performing the service activity.

In an example, the range can begin at a value of the parameter at an initial event that is at least one of: when the end-user obtained the vehicle, when a previous end-user of the vehicle obtained the vehicle, a beginning of a calendar year, a beginning of a fiscal year of the end-user, an initial service activity performed on the vehicle, a mileage threshold of the vehicle, and a significant event of the end-user.

In an example, the parameter can be a date and the interval can be at least one of: a range of consecutive years, a year, a half-year, a quarter, a trimester and a month. In an example, the parameter can be an accumulated mileage and the interval can be at least one of: 100,000 miles, 50,000 miles, 20,000 miles, 10,000 miles, 5,000 miles, 2,000 miles, 1,000 miles, 500 miles, 250 miles, 100 miles, 50 miles, 200,000 km, 100,000 km, 50,000 km, 20,000 km, 10,000 km, 5,000 km, 2,000 km, 1,000 km, 500 km, 250 km and 100 km.

In an example, the attribute extracted can be at least one of: a total service cost, an average service cost, a median service cost, a number of service appointments, a number of service activities, a category of service activities, a type of service activity, a total duration of service activities, an average duration of service activities, a median duration of service activities, a number of days in a service facility, a duration of a service activities and a number of unit hours incurred in a service activity of the data in the set.

In an example, the service facility can be at least one of: an automotive repair facility, a fuel refilling station, a car dealership, a service department of a dealership, a parts department of a dealership, a government vehicle registry, and another end-user.

In an example, the action of receiving can comprise actions of: receiving a comparison report request, juxtaposing at least one of the trend and the ordered data against an estimate of vehicle service costs for at least one interval within the range and creating a comparison report responsive thereto.

In an example, the action of receiving can comprise actions of: receiving a history report request, listing at least a subset of all data associated with the vehicle and creating a history report responsive thereto.

In an example, the action of receiving can comprise actions of: obtaining at least one use datum, each identifying a subset of the range, receiving a use category report request and allocating the data associated with the vehicle within the range to one of a plurality of use categories, based on the use data, allocating each at least one use datum to one of the categories and creating a use category report responsive thereto. In an example, the use data can be obtained from at least one of: a processor of the end-user and the end-user.

In an example, the action of receiving can comprise: accumulating the data associated with at least one vehicle of the end-user in the range and awarding at least one entitlement under a customer loyalty program (CLP) conditioned on at least one of: the vehicle and the end-user, when at least one threshold of the CLP is exceeded by a feature of the accumulated data. In an example, the feature can be at least one of: the total service cost, a number of service activities and a type of service activity of the accumulated data in the range.

Examples have been described above in conjunction with aspects of the present disclosure upon which they can be implemented. Those skilled in the art will appreciate that examples may be implemented in conjunction with the aspect with which they are described, but may also be implemented with other examples of that or another aspect. When examples are mutually exclusive, or are otherwise incompatible with each other, it will be apparent to those having ordinary skill in the relevant art. Some examples may be described in relation to one aspect, but may also be applicable to other aspects, as will be apparent to those having ordinary skill in the relevant art.

Some aspects or examples of the present disclosure may provide a system to generate, at least one datum related to an actual cost of servicing a vehicle at a point of sale of such service, and to determine a trend of such actual point of sale vehicle service costs as a function of a trend parameter, such as, without limitation, date, time and/or accumulated mileage therefrom, and use of such system in a method to provide such trends to an end-user.

### DESCRIPTION

The present disclosure provides an example of a system for tracking a trend, as a function of a trend parameter, such as date, time and/or accumulated mileage, of actual point of sale costs of maintenance and/or operation of a vehicle.

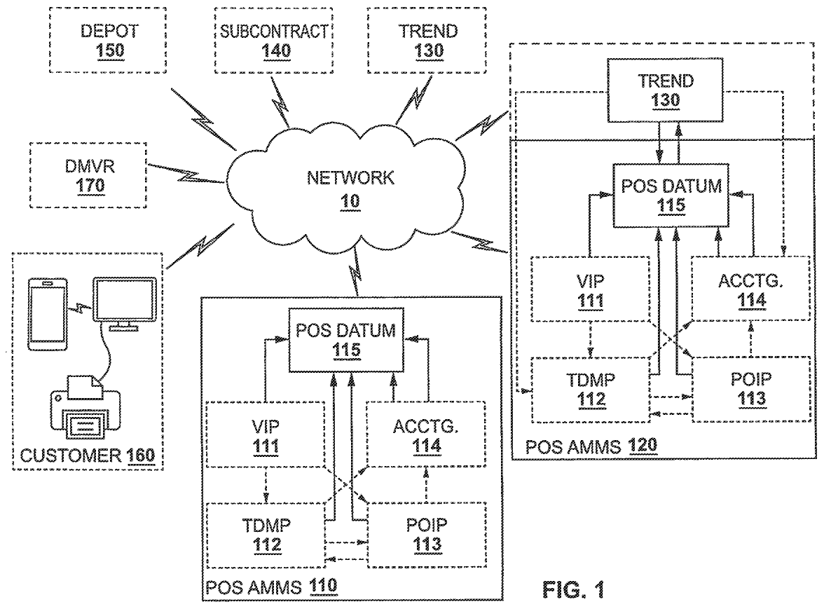

FIG. 1 is a simplified block diagram of a system, shown generally at 100, for generating actual point of sale vehicle service cost trends, from vehicle service cost information generated at a point of sale (POS) of an automotive maintenance management system (AMMS) in relation to at least one service activity performed at or by service personnel of a service facility managed by the POS AMMS according to the present disclosure.

The term “point of sale” refers to the fact that at least one datum from which such trends are derived, is obtained by the system 100 directly from the AMMS at the POS where the service activity is performed and charged to the end user.

For purposes of simplicity of discussion, it will be understood that the term “facility” may be understood to include any after-market enterprise, such as a fuel refilling station (such as a gas station and/or an electric recharging site) and/or automobile repair facility, devoted to the service of such vehicles after delivery to an end-user. Further, the term “facility” may be considered, in some non-limiting examples, to encompass the parts and/or parts divisions of a new car dealership.

Still further, such a term may be considered to extend to the sales department of such a dealership and/or a pre-owned vehicle division thereof and/or a used car dealership, and in some non-limiting examples, the term “facility” may be considered to encompass another end-user from whom the end-user obtained the vehicle and/or a government vehicle registry, such as a department of motor vehicles (DMV) registry and/or a resource providing access to records therefrom (DMVR). With such an extended definition, it will be appreciated that the concept of service costs may be extended to encompass all costs associated with the vehicle including the costs incurred by an end-user to obtain the vehicle and then to maintain its annual registration.

For purposes of simplicity of discussion, it will be understood that the term “service personnel” may be understood to include any person associated with the facility, including, without limitation, an owner, operator, employee and/or technician.

The system 100 comprises a number of subsystems, coupled by a communications network 10. The subsystems comprise at least one POS AMMS 110, 120 and at least one trend generator 130 associated therewith. In some non-limiting examples, such as shown in respect of POS AMMS 120, the trend generator 130 forms part of and communicates directly with components of the POS AMMS 120 associated therewith.

In addition to the POS AMMS 110, 120, the subsystems may optionally comprise a service subcontractor 140, a parts depot 150, a customer access portal 160 and/or a DMVR 170 coupled to the POS AMMS 110, 120 and/or to the trend generator(s) 130 associated therewith, by the network 10.

### POS AMMS

Each POS AMMS 110, 120 comprises a number of components to manage and perform service activities at a vehicle service facility. In some non-limiting examples, the facility may comprise a fuel refilling station. In some non-limiting examples, the facility may be an independent operation. In some non-limiting examples, the facility may be part of a chain of associated facilities, including without limitation, a dealer network or a network of franchises or locations of a service operation.

Where the facility is part of a chain of associated facilities, the POS AMMS 110, 120 of an individual facility may have access, through the network 10, to a central trend generator 130, which may be housed within and/or associated with another POS AMMS 120, or be independent of any POS AMMS 110. Where the facility is an independent operation, the associated POS AMMS 110, 120 may maintain its own trend generator 130, such as is shown for POS AMMS 120. It will be appreciated that there may be one or more independent trend generators 130 to which the POS AMMS 110, 120 of an individual facility or one or more facilities in a chain may be associated with and/or subscribe, instead of or in addition to its own associated trend generator 130.

The components of each POS AMMS 110, 120 comprises at least one POS datum generator 115. In addition to the POS datum generator 115, an POS AMMS 110, 120 may comprise any one or more of: a vehicle intake processor (VIP) 111, a technician data management processor (TDMP) 112, a parts ordering/inventory processor (POIP) 113 and an accounting processor 114.

Vehicle Intake Processor (VIP)

If present, the VIP 111, which in some non-limiting examples, may comprise and/or be implemented by or in one or more software or other processing and/or algorithmic modules, accepts inputs from service personnel (not shown) at an I/O device (not shown) coupled to the VIP 111, whether directly or indirectly through a bus, a network interface and/or an I/O interface, and generates outputs to the POS datum generator 115 and, in some non-limiting examples, to the TDMP 112, to service personnel (not shown) at an I/O device (not shown) and/or to the POIP 113. In some non-limiting examples, the VIP 111 may accept inputs from and generate outputs to the customer access portal 160. In some non-limiting examples, the VIP 111 may accept inputs from the trend generator(s) 130 associated with the POS AMMS 110, 120 housing the VIP 111.

However obtained, the inputs are associated with the arrival of a vehicle to the facility associated with the POS AMMS 110, 120 housing the VIP 111. In some non-limiting examples, the inputs may comprise information associated with the vehicle, information associated with the end-user, and information associated with the service activity to be performed.

In some non-limiting examples, the information associated with the vehicle may include any one or more of the vehicle identification number (VIN) of the vehicle, which is a unique identifier associated with each vehicle, the license plate number of the vehicle, the vehicle ownership registration, the vehicle insurance information, the identity of the end-user, the year, make, model, colour, trim level and/or odometer reading of the vehicle. In some non-limiting examples, the information associated with the vehicle may also, or in the alternative, include any one or more of: the date that the end-user obtained the vehicle, the odometer reading of the vehicle at the date that the end-user obtained the vehicle, and/or the identity, date obtained and/or odometer reading of the vehicle at the date that one or more previous end-users of the vehicle obtained the vehicle.

In some non-limiting examples, the information associated with the end user may include the end-user's name, address, contact information and/or user identification and/or the name, address, contact information and/or billing information of the customer associated with the end-user (if different).

In some non-limiting examples, the information associated with the service activity to be performed may include a problem reported by the end-user, the date, time, additional service activities to be performed (including without limitation, installation, storage and/or rotation of tires, oil change, filter change, hose replacement and/or fluid replenishment) and/or an estimate of the cost of any or all such service activities.

In some non-limiting examples, the information associated with the service activity to be performed may access and make use of information maintained and generated by the trend generator(s) 130 associated with the POS AMMS 110, 120 housing the VIP 111, including without limitation, the passage of time and/or mileage accumulated by the vehicle since a prior event, including without limitation, a service activity.

In some non-limiting examples, any one or more of the inputs to the VIP 111 are associated with a datum associated with the end-user, such as a user identification, within the VIP 111, such that other inputs to the VIP 111 may be stored, in association with the datum, and accessed by the vehicle input portal 111, upon input of the datum at the VIP 111.

In some non-limiting examples, the VIP 111 accepts such inputs at one or more input/output (I/O) devices (not shown) coupled thereto, whether directly or indirectly through a bus, a network interface and/or an I/O interface.

By way of non-limiting example, the VIN may be recorded by a scanner operated automatically and/or by service personnel (not shown) and/or entered at a computer terminal by service personnel (not shown), whereas other information associated with the end-user may be entered at a computer terminal by service personnel (not shown).

In some non-limiting examples, some or all of the inputs provided by service personnel (not shown) at the I/O device (not shown) may be prompted by, and/or prompt a response outputted by the VIP 111 to service personnel (not shown) at the I/O device (not shown).

In some non-limiting examples, some or all of the inputs may be provided remotely across the network 10 by the end-user (not shown) at the customer access portal 160, in advance of the arrival of the vehicle at the facility, including, without limitation, to schedule a service activity and/or when a service activity is scheduled, and may be independently verified automatically and/or by service personnel (not shown) when the vehicle arrives at the facility. In some non-limiting examples, some or all of the inputs provided at the customer access portal 160 may be prompted by, and/or prompt a response, whether automatically and/or under direction of and/or input from service personnel (not shown), outputted by the VIP 111 to the end-user (not shown) at the customer access portal 160. In some non-limiting examples, the VIP 111 may generate outputs to the end-user (not shown) at the customer access portal 160 to confirm the scheduling of a service activity. In some non-limiting examples, the VIP 111 and the end-user (not shown) at the customer access portal 160 may generate outputs and receive inputs to schedule, reschedule and/or cancel scheduled appointments.

The VIP 111 generates outputs to the POS datum generator 115 and, in some non-limiting examples, to the TDMP 112 and/or to the POIP 113. In some non-limiting examples, such outputs, include, without limitation, the information associated with the vehicle, information associated with the end-user and/or information associated with the service activity to be performed, and/or one or more subsets and/or supersets thereof.

Technician Data Management Processor (TDMP)

If present, the TDMP 112, which in some non-limiting examples, may comprise and/or be implemented by or in one or more software or other processing and/or algorithmic modules, may accept as input, outputs from any one or more of the VIP 111 and the trend generator(s) 130 associated with the POS AMMS 110, 120 housing the TDMP 112, and generates outputs to service personnel (not shown) at an I/O device (not shown) coupled to the TDMP 112, whether directly or indirectly through a bus, a network interface and/or an I/O interface.

In some non-limiting examples, the inputs may comprise information associated with the vehicle, information associated with service personnel and/or information associated with the service activity to be performed.

In some non-limiting examples, the information associated with the vehicle may comprise and/or be a subset and/or superset of the information associated with the vehicle obtained from the VIP 111.

In some non-limiting examples, the information associated with service personnel may comprise an assigned technician identifier, an assigned technician name, a facility location, a technician rate and/or one or more subsets and/or supersets thereof.

In some non-limiting examples, the information associated with the service activity to be performed may comprise a start date, a start time, a description of the action, a job code, an advisory note, and/or one or more subsets and/or supersets thereof.

In some non-limiting examples, the inputs from service personnel (not shown) at the I/O device (not shown) may comprise and/or be a subset and/or superset of the information associated with the vehicle, information associated with service personnel and/or information associated with the service activity to be performed obtained from the VIP 111, such as, in some non-limiting examples, where there is no VIP 111 in the POS AMMS 110, 120 housing the TMDP 112.

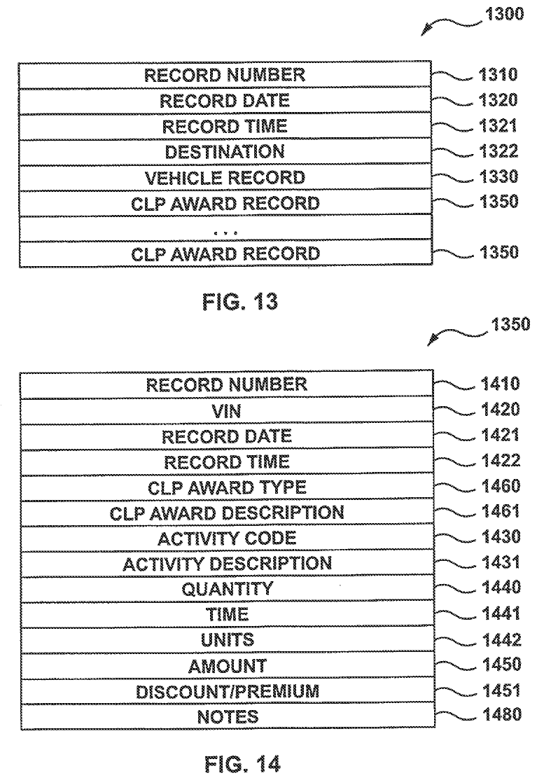

In some non-limiting examples, the TDMP 112 may accept, from the trend generator(s) 130 associated with the POS AMMS 110, 120 housing the TDMP 112, inputs comprising at least one additional service activity to be performed at the instance of a customer loyalty program (CLP) within the trend generator(s) 130. In some non-limiting examples, such inputs may be in the form of a CLP entitlement datum 1300 (FIG. 13).

The TDMP 112 presents information to service personnel at an I/O device (not shown) that allows service personnel to understand and perform the service activity to be performed on the vehicle. In some non-limiting examples, the information comprises information associated with the vehicle, information associated with the end-user and/or information associated with the service activity to be performed obtained from the VIP 111 and/or one or more subsets and/or supersets thereof.

In some non-limiting examples, the information comprises information stored within the TDMP 112 or accessible from an internal and/or external resource (not shown) whether or not coupled by the network 10. In some non-limiting examples, the TDMP 112 accepts inputs from service personnel at an I/O device (not shown) that specifies the information to be accessed. In some non-limiting examples, inputs from service personnel and/or outputs to service personnel at an I/O device (not shown) facilitate interactive access by the technician of such resources.

By way of non-limiting example, an internal resource could comprise codes, standards, thresholds, instructions and/or policies (including, without limitation, the authorized service subcontractor(s) 140 for a given outsource service activity) maintained by and/or for the facility. By way of non-limiting example, an external resource could comprise a service manual, warranty information, videos of example maintenance actions and/or techniques and/or contact information relating to authorized and/or other service subcontractor(s) 140 for a given outsource service activity.

In some non-limiting examples, the TDMP 112 may generate outputs to and/or accept inputs from the service subcontractor(s) 140 along the network 10.

By way of non-limiting example, if the POS AMMS 110, 120 housing the TDMP 112 does not provide or have facilities and/or service personnel to perform one or more of specified service activities to be performed on the vehicle, it may communicate with the service subcontractor(s) 140 along the network 10 to identify, order, to arrange for, and/or accept, delivery of and/or payment and/or invoicing of, one or more of the specified service activities, based on the information associated with the service activity to be performed, together with information associated therewith and/or derived therefrom, including without limitation, billing and/or credit information, as well as delivery information of the facility.

In some non-limiting examples, the service subcontractor 140 may form part of the same organization as the POS AMMS 110, 120 housing the TDMP 112.

Such subcontracted services may include, without limitation, front end alignment, rustproofing, painting and/or collision repair service activities.

In such scenarios, the inputs and outputs between the TDMP 112 effects the delivery of the vehicle to the service subcontractor 140, performance of the specified subcontracted service(s) thereon and return of the vehicle to the POS AMMS 110, 120 housing the TDMP 112.

In some non-limiting examples, the service subcontractor 140 may be independent of the POS AMMS 110, 120 housing the TDMP 112.

Such subcontracted services may include, without limitation, in addition to or in the alternative to one or more of the subcontracted services identified above, muffler and exhaust, audio, video and alarm installation and removal and/or vehicle customization service activities. In such scenarios, the inputs and outputs between the TDMP 112 effect the order and/or invoicing of such subcontracted service(s), in addition to the delivery of the vehicle to and from the service subcontractor 140 to the POS AMMS 110, 120 housing the TDMP 112 for the performance of the specific subcontracted service(s) thereon.

In some non-limiting examples, the TDMP 112 may generate outputs to and/or accept inputs from the POIP 113.

In some non-limiting examples, the service personnel may specify to the TDMP 112, information associated with one or more parts for use in the service operation. In some non-limiting examples, the information associated with one or more parts may comprise a part name, part description, part number, inventory number and/or quantity. Additionally, and/or alternatively, the information associated with one or more parts may comprise and/or be a subset and/or superset of the information associated with the vehicle.

Such information may cause the TDMP 112 to generate an output to the POIP 113 comprising and/or being a sub set and/or superset of the information associated with one or more parts obtained from service personnel, to cause the specified part(s) to be made available to service personnel, and/or to receive an input from the POIP 113 notifying the TDMP 112 where and when the specified part is available.

The TDMP 112 also accepts inputs from service personnel (not shown) at an I/O device (not shown) coupled to the TDMP 112, whether directly or indirectly through a bus, a network interface and/or an I/O interface and generates outputs to the POS datum generator 115 and/or, in some non-limiting examples, to the accounting processor 114.

In some non-limiting examples, the inputs from service personnel at an I/O device (not shown) specifies actions performed by service personnel on the vehicle in accordance with the service activity to be performed.

In some non-limiting examples, the information associated with the service activity performed may comprise a start date, an end date, a start time, an end time, an elapsed time, a description of the action, a job code, a job rate, an advisory note, an observation, a reminder for follow up and/or for future action and/or one or more subsets and/or supersets thereof.

In some non-limiting examples, the information associated with the inputs and/or derived therefrom may comprise, in addition to or in substitution for one or more of such inputs, a prepared text description of the activity, an amount to be charged and/or one or more subsets and/or supersets thereof.

The outputs of the TDMP 112 to the POS datum generator 115 may comprise information associated with the actions performed by service personnel on the vehicle in accordance with the service activity to be performed, information processed and/or derived therefrom and, in some non-limiting examples, in addition to or in substitution therefor, a prepared text description of the service activity, a length of time and/or a number of units relating to the duration and/or quantity of an action performed, a discount and/or premium charged and/or one or more subsets and/or supersets thereof.

If one or more of the service activities has been subcontracted out to the service subcontractor 140, the outputs may also comprise, in addition to or in substitution for one of the information associated with one or more of the actions performed by service personnel on the vehicle, a prepared text description of the subcontracted service(s) an identity of the service subcontractor 140, a discount and/or premium charged and/or one or more subsets and/or supersets thereof. In addition, if the service subcontractor 140 is independent of the POS AMMS 110, 120 housing the TDMP 112, the outputs may comprise a received invoice and/or data contained thereon, a discount and/or premium charged, a delivery charge and/or one or more subsets and/or supersets thereof.

If one or more of the service activities resulted in a communication to the POW 113 for one or more parts for use in the service activity, the outputs may also comprise, in addition to or in substitution for one of the information associated with one or more of the actions performed by service personnel on the vehicle, an indication that one or parts were requested from the POIP 113.

In some non-limiting examples, the TDMP 112 may provide outputs to the accounting processor 114 that may comprise the outputs that the technician data management module 112 may provide to the POS datum generator 115 and/or one or more subsets and/or supersets thereof. In some non-limiting examples, if outputs are provided to the accounting processor 114, some or all of the outputs to the POS datum generator 115 may be dispensed with, since the accounting processor 114 will be understood to provide them to the POS datum generator 115.

### Parts Ordering/Inventory Processor (POIP)

If present, the POIP 113, which in some non-limiting examples, may comprise and/or be implemented by or in one or more software or other processing and/or algorithmic modules, accepts as input, information associated with one or more parts outputted from the TDMP 112, and/or inputs from service personnel (not shown) at an I/O device (not shown) coupled to the POIP 113, whether directly or indirectly through a bus, a network interface and/or an I/O interface, processes such inputs and forwards information associated therewith and/or derived therefrom to the POS datum generator 115 and, in some non-limiting examples, forwards the same or different inputs, information associated therewith and/or derived therefrom to the accounting processor 114.

In some non-limiting examples, the inputs from service personnel (not shown) at the I/O device (not shown) may comprise and/or be a subset and/or superset of the information associated with one or more parts otherwise to be obtained from the TDMP 112, such as, in some non-limiting examples, where there is no TDMP 112 in the POS AMMS 110, 120 housing the POW 113.

Those having ordinary skill in the relevant art will appreciate that in some non-limiting examples, the facility may operate a parts department separately from the service operation, in which case, the POIP 113 may also accept as inputs, outputs generated by the VIP 111 and/or a customer request, directly from one or more customer access portal 160, without involving the TDMP 112. Such inputs may comprise and/or be a subset and/or superset of the information associated with one or more parts otherwise to be obtained from the TDMP 112 and/or as inputs from service personnel (not shown) at the I/O device (not shown).

In some non-limiting examples, the POIP 113 generates outputs to and/or accepts inputs from the parts depot 150 along the network 10.

By way of non-limiting example, if the POIP 113 does not have one or more of the parts on hand, it may communicate with the parts depot 150 along the network 10 to identify, order, to arrange for, and/or accept, delivery of and/or payment and/or invoicing of, one or more of the specified parts, based on the information associated with one or more parts obtained from the TDMP 112, together with information associated therewith and/or derived therefrom, including without limitation, billing and/or credit information, as well as delivery information of the facility.

In some non-limiting examples, the parts depot 150 may form part of the same organization as the POS AMMS 110, 120 housing the POIP 113, such that the inputs and outputs between the POIP 113 affect the delivery of one or more parts from the parts depot 150 to the POS AMMS 110, 120. In some non-limiting examples, the parts depot 150 may be independent of the POS AMMS 110, 120 housing the POIP 113, such that the inputs and outputs between the POIP 113 effect the order and/or invoicing of such parts, in addition to their delivery from the parts depot 150 to the POS AMMS 110, 120.

Whether or not the POIP 113 communicates with the parts depot 150, outputs of the POIP 113 to the POS datum generator 115 may comprise, in addition to or in substitution for one of the information associated with one or more parts, a prepared text description of the part, a discount and/or premium charged and/or one or more subsets and/or supersets thereof. In addition, if the POIP 113 has obtained one or more parts from the parts depot 150, the outputs may comprise a received invoice and/or data contained thereon, a discount and/or premium charged, a delivery charge and/or one or more subsets and/or supersets thereof.

In some non-limiting examples, one or more parts used in provision of a given service activity may be Internet of Things (IoT)-enabled, such that it may exchange, from time to time, including upon request, wireless communications with the network 10 independently of human action. Such communications, may, without limitation, extend to a diagnostic and/or operational status. If so enabled, outputs of the POIP 113 to the POS datum generator 115 may comprise, in addition to or in substitution of the foregoing, an IoT address or other identifying data facilitating the identification and/or tracking of such IoT-enabled device.

In some non-limiting examples, the POIP 113 may provide outputs to the accounting processor 114 that may comprise the outputs that the ports ordering/inventory module 113 may provide to the POS datum generator 115 and/or one or more subsets and/or supersets thereof. In some non-limiting examples, if outputs are provided to the accounting processor 114, some or all of the outputs to the POS datum generator 115 may be dispensed with, since the accounting processor 114 will be understood to provide them to the POS datum generator 115.

### Accounting Processor

If present, the accounting processor 114, which in some non-limiting examples, may comprise and/or be implemented by or in one or more software or other processing and/or algorithmic modules, accepts as input, outputs from any one or more of: the TDMP 112, the POIP 113, one or more of the trend generators 130 associated with the POS AMMS 110, 120 housing the accounting processor 114 and/or inputs from service personnel (not shown) at an I/O device (not shown) coupled to the accounting processor 114, whether directly or indirectly through a bus, a network interface and/or an I/O interface, and generates outputs to the POS datum generator 115 and/or to service personnel (not shown) at an I/O device (not shown).

The accounting processor 114 maintains accounting information associated with the facility, including without limitation, capital and/or overhead expenses associated with the facility, as well as direct expenses associated with payroll relative to work performed by service personnel (not shown) and/or associated with materials used in performance of such work, including without limitation, parts identified to the POIP 113.

In some non-limiting examples, the invoice-related functions are provided by the POS datum generator 115 from inputs, related to the service activity being performed, that are provided directly to the POS datum generator 115 from any one or more of: the TDMP 112, the POIP 113 and/or the trend generator(s) 130 associated with the POS AMMS 110, 120 housing the accounting processor 114. In such scenario, the outputs from the accounting processor 114 to the POS datum generator 115 comprise only such information maintained by the accounting processor 114 and relevant to the generation of the invoices by the POS datum generator 115 that is not otherwise independently available to the POS datum generator 115. Non-limiting examples of such information includes any balance payable, and/or information related to the end-user, whether or not associated with the particular vehicle being serviced.

Alternatively, in some non-limiting examples, the accounting processor 114 performs substantially all relevant accounting functions, in which case the outputs from the accounting processor 114 to the POS datum generator 115 may comprise substantially all of the information by which the invoice can be generated by the POS datum generator 115 and the outputs, from any one or more of: the TDMP 112, POIP 113 and/or the trend generator(s) 130 associated with the POS AMMS 110, 120 housing the POS datum generator 115, to the POS datum generator 115 may be reduced, summarized and/or dispensed with, such outputs being substantially the same, or of a subset of the outputs, from any one or more of the TDMP 112, the POIP 113 and/or the trend generator(s) 130 associated with the POS AMMS 110, 120 housing the accounting processor 114.

### POS Datum Generator

The POS datum generator 115, which in some non-limiting examples, may comprise and/or be implemented by or in one or more software or other processing and/or algorithmic modules, accepts as input, outputs from, without limitation, any one or more of: the TDMP 112, the POIP 113, the accounting processor 114, the trend generator(s) 130 associated with the POS AMMS 110, 120 housing the POS datum generator 115, and/or inputs from service personnel (not shown) at an I/O device (not shown) coupled to the POS datum generator 115, whether directly or indirectly through a bus, a network interface and/or an I/O interface.

The outputs of the TDMP 112 to the POS datum generator 115 may comprise information with the actions performed by service personnel on the vehicle in accordance with the service activity to be performed, information processed and/or derived therefrom, and in some non-limiting examples, in addition to or in substitution therefor, a prepared text description of the service activity, a length of time and/or a number of units relating to the duration and/or quantity of an action performed, a discount and/or premium charged and/or one or more subsets and/or supersets thereof.

If one or more of the service activities has been subcontracted out to the service subcontractor 140, the outputs may also comprise, in addition to or in substitution for one of the information associated with one or more of the service activities, a prepared text description of the subcontracted service(s), an identity of the service subcontractor 140, a discount and/or premium charged and/or one or more subsets and/or supersets thereof. In addition, if the service subcontractor 140 is independent of the POS AMMS 110, 120 housing the TDMP 112, the outputs may comprise a received invoice and/or data contained thereon, a discount and/or premium charged, a delivery charge and/or one or more subsets and/or supersets thereof.

If one or more of the service activities resulted in a communication to the POW 113 for one or more parts for use in the service activity, the outputs may also comprise, in addition to or in substitution for one of the information associated with one or more of the actions performed by service personnel on the vehicle, an indication that one or parts were requested from the POIP 113.

The outputs of the POIP 113 to the POS datum generator 115 may comprise, in addition to or in substitution for one of the information associated with one or more parts, a prepared text description of the part, a discount and/or premium charged and/or one or more subsets and/or supersets thereof.

If the POIP 113 has obtained one or parts from the parts depot 150, the outputs may comprise a received invoice and/or data contained thereon, a discount and/or premium charged, a delivery charge and/or one or more subset and/or supersets thereof.

The outputs from the accounting processor 114 to the POS datum generator 115 comprises, without limitation, accounting information that may support generation of invoices by the POS datum generator 115.

In some non-limiting examples, the POS datum generator 115 may provide the invoice-related functions from inputs, related to the service activity being performed, that are provided directly to the POS datum generator 115 from any one or more of: the TDMP 112, the POIP 113 and/or the trend generator(s) 130 associated with the POS AMMS 110, 120 housing the POS datum generator 115, as discussed herein. In such scenario, the outputs from the accounting processor 114 to the POS datum generator 115 comprise only such information maintained by the accounting processor 114 and relevant to the generation of the POS electronic data 200 and/or invoices by the POS datum generator 115 that is not otherwise independently available to the POS datum generator. Non-limiting examples of such information includes any balance payable, and/or information related to the end-user, whether or not associated with the particular vehicle being serviced.

Alternatively, in some non-limiting examples, the accounting processor 114 performs substantially all relevant accounting functions, in which case the outputs from the accounting processor 114 to the POS datum generator 115 may comprise substantially all of the information by which the POS electronic data 200 and/or invoice can be generate by the POS datum generator 115 and the outputs, from any one or more of: the TDMP 112, POIP 113 and/or the trend generator(s) 130 associated with the POS AMMS 110, 120 housing the POS datum generator 115, to the POS datum generator 115 may be reduced, summarized and/or dispensed with, such outputs being substantially the same, or of a subset of the outputs, from any one or more of the TDMP 112, the POIP 113 and/or the trend generator(s) 130 associated with the POS AMMS 110, 120 housing the accounting processor 114.

The outputs of the trend generator(s) 130 associated with the POS AMMS 110, 120 housing the POS datum generator 115 may comprise at least one entitlement under a CLP, in the form of, without limitation, a rebate on past service activity that may impact the generation of any POS electronic data 200 and/or invoice by the POS datum generator 115. In addition and/or in the alternative, the trend generator(s) 130 associated with the POS AMMS 110, 120 housing the POS datum generator 115 may comprise information relating to accrued, or partially accrued entitlements under the CLP that may be set out on the invoice generated by the POS datum generator 115 for the information of the end-user. Such information may identify that an accrued entitlement under the CLP has been awarded, without limitation, by a funds transfer (in the case of a rebate), a communication to the TDMP 1123 associated with the POS AMMS 110, 120 housing the POS datum generator 113 (or another POS AMMS 110, 120) authorizing performance of an additional service activity, and/or a voucher or coupon for a complimentary product, additional service activity, to the end-user along the network 10 to the customer access portal 160, including without limitation, as an output on a software app on a mobile device 163 of the end-user that forms part of the customer access portal 160 or is coupled thereto. In some non-limiting examples, such inputs may be in the form of a CLP entitlement datum 1300 (FIG. 13). Additionally, the POS datum generator 115 may derive information from other components of the POS AMMS 110, 120 associated therewith, including without limitation, the VIP 111, the TDMP 112, the POIP 113 and/or the accounting processor 114, and/or the trend generator(s) associated with the POS AMMS 110, 120 housing the POS datum generator 115, relating to, without limitation, previously scheduled service appointments and/or reminders for upcoming service activities that have not been previously scheduled (including, without limitation, accrued entitlements from the CLP) for the particular vehicle being serviced and/or any other vehicles of the end-user thereof, which may, in some non-limiting examples be presented as part of the invoice(s) and/or electronic datum/data generated by the POS datum generator 115 reflective of the service performed on the vehicle at the POS AMMS 110, 120 housing the POS datum generator 115, as discussed herein.

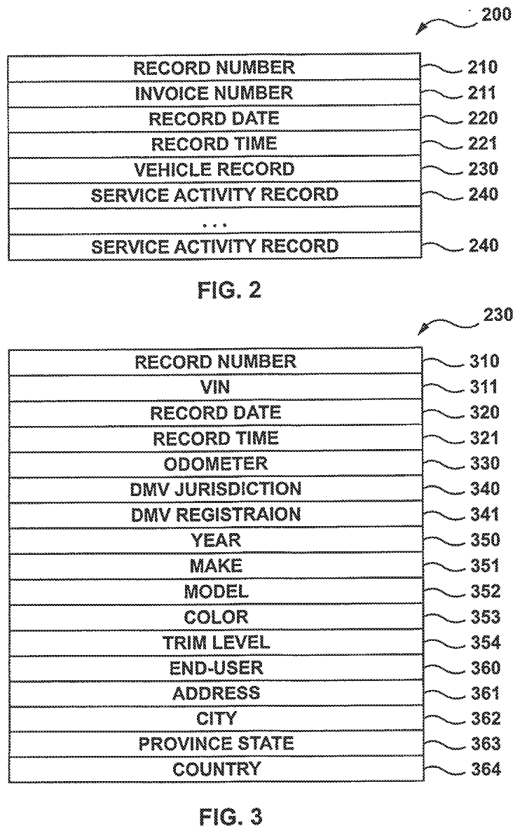

The POS datum generator 115 processes such information and generates outputs, in the form of POS electronic data 200 (FIG. 2) reflective of the service activity performed on the vehicle at the POS AMMS 110, 120 housing the POS datum generator 115, to the trend generator(s) 130 associated with the POS AMMS 110, 120 housing the POS datum generator 115. In some non-limiting examples, the POS datum generator 115 also generates outputs in the form of POS electronic data 200 and/or a printed invoice to service personnel (not shown) at an I/O device (not shown). In some non-limiting examples, the POS datum generator 115 may generate outputs in the form of POS electronic data 200 and/or a printed invoice to the customer access portal 160.

The POS datum generator 115 generates POS electronic data 200 reflective of the service activity performed on the vehicle at the POS AMMS 110, 120 housing the POS datum generator 115 substantially contemporaneously with the completion by the service personnel (not shown) of the service activity at the facility and forwards such electronic data to the at least one trend generator 130 associated with the POS AMMS 110, 120 housing the POS datum generator 115. Data from the POS electronic data is incorporated by the at least one trend generator 130 associated with the POS AMMS 110, 120 to generate actual vehicle service cost trends as a function of a trend parameter such as, without limitation, date, time and/or accumulated mileage, according to the present disclosure.

Those having ordinary skill in the relevant art will appreciate that since, as disclosed herein, the POS datum generator 115 is housed in, or is proximate to the POS AMMS 110, 120 associated with the facility at which the service activity was performed and the POS electronic data 200 generated thereby is generated substantially contemporaneously with the completion by service personnel (not shown) of the service activity at the facility, the electronic data generated thereby is considered to be generated at the POS of the service activity, even though the POS AMMS 110, 120 may or may not be co-located with the trend generator(s) 130 associated therewith.

In some non-limiting examples, the POS datum generator 115 also generates outputs in the form of POS electronic data 200 and/or a printed invoice at an I/O device (not shown) coupled to the POS datum generator 115, whether directly or indirectly through a bus, a network interface and/or an I/O interface, for access by service personnel (not shown). In some non-limiting examples, such invoice may be provided by such service personnel to the end-user.

In some non-limiting examples, the POS electronic data 200 may be provided across the network 10 to the end-user (not shown) at the customer access portal 160. In some non-limiting examples, the provision of the POS electronic data 200 may be prompted by an input by the end-user (not shown) at the customer access portal 160, including without limitation, as an output on a software app on a mobile device 163 of the end-user that forms part of the customer access portal 160 or is coupled thereto, signalling a request for such invoice. In some non-limiting examples, some or all of the inputs provided at the customer access portal 160 may be prompted by and/or prompt a response, whether automatically and/or under direction of and/or input from service personnel (not shown), outputted by the POS datum generator 115 to the end-user (not shown) at the customer access portal 160.

In some non-limiting examples, when the POS electronic data 200 is provided at the customer access portal 160, a printed invoice may be generated therefrom at the customer access portal 160, including without limitation, as an output on a software app on a mobile device 163 of the end-user that forms part of the customer access portal 160 or is coupled thereto, for access by the end-user (not shown). It will be appreciated that such printed invoice is not generated at the POS AMMS 110, 120 where the service personnel (not shown) of the facility performed the service activity, and that such printed invoice may not be generated substantially contemporaneously with the completion by the service personnel (not shown) of the service activity, such printed invoice may not be considered to be a POS datum.

### POS Electronic Data

Turning now to FIG. 2, there is shown an example format of a POS electronic datum 200 generated by the POS datum generator 115 for receipt, without limitation, by the trend generator(s) 113 associated with the AMMS 110, 120 housing the POS datum generator 115.

In some non-limiting examples, the POS electronic datum 200 comprises a unique record number 210, an associated invoice number 211, a date 220 and/or a time 221 that the POS electronic datum 200 was recorded, a vehicle datum in the form of a vehicle record 230 and/or at least one service activity datum in the form of a service activity record 240.

FIG. 3 is an example format of the vehicle record 230 that forms part of the POS electronic datum 200. In some non-limiting examples, the vehicle record 230 comprises a unique record number 310, a unique identifier of the vehicle, such as a VIN 311, a date 320 and/or a time 321 that the vehicle record 230 was recorded, values representing a mileage of the vehicle as shown on the odometer 330, a government registration identifier, in the form of a DMV jurisdiction 340 and registration number 341, identification describing the vehicle, in the form of a year 350, make 351, model 352, color 353 and/or trim level 354 of the vehicle and/or information describing the (current) end-user of the vehicle, in the form of an end-user identity 360, an address 361, a city 362, a jurisdiction 363 and/or a country 364.

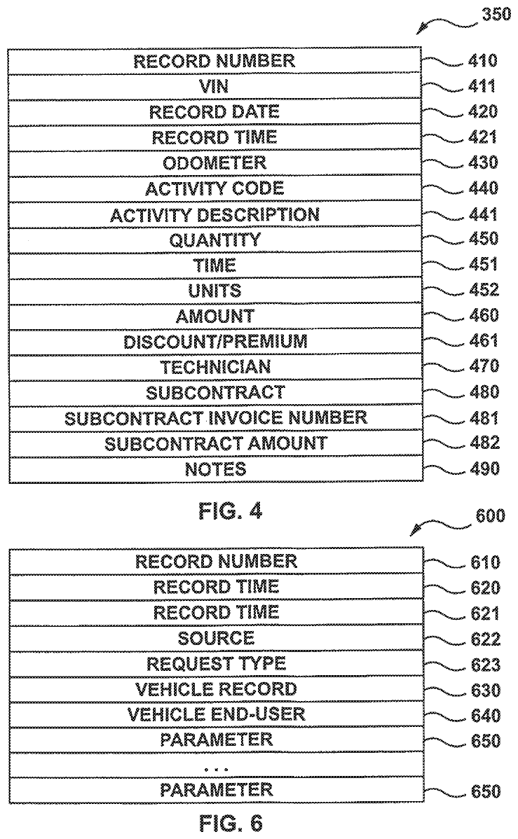

FIG. 4 is an example format of the service activity record 240 that forms part of the POS electronic datum 200. In some non-limiting examples, the service activity record 240 comprises a unique record number 410, a unique identifier of the vehicle, such as a VIN 411, a date 420 and/or a time 421 that the service activity record 240 was recorded, values representing a mileage of the vehicle as shown on the odometer 430, values representing information describing the service activity, in the form of an activity code 440, an activity description 441, a technician 470, a subcontract 480 (which may represent either of a parts depot 140 and/or a service subcontractor 150) and/or notes 490, and/or information describing a service cost of performing the service activity, in the form of a quantity 450, a time 451, a number of units 452, an amount 460, a discount or premium applied thereto 461, a subcontract invoice number 481, and/or a subcontract amount 482.

The notes 490 field in the service activity record 240 may be used to house information to appear in conjunction with the information in the POS electronic datum 200, including without limitation, notes provided by service personnel at the TDMP 112, the POIP 113, the accounting processor 114, including without limitation, any balance payable, and/or information related to the end-user, whether or not associated with the particular vehicle being serviced, and/or information provided by the trend generator(s) 130 associated with the POS AMMS 110, 120 housing the POS datum generator 115, including without limitation, any entitlement under the CLP, in the form of, without limitation, a rebate on past service activity that may impact the generation of any POS electronic datum 200 and/or invoice by the POS datum generator 115, information relating to accrued, or partially accrued entitlements under the CLP, including without limitation, identifying that an accrued entitlement under the CLP has been awarded, without limitation, by a funds transfer (in the case of a rebate), a communication to the TDMP 112 associated with the POS AMMS 110, 120 housing the POS datum generator 113 (or another POS AMMS 110, 120) authorizing performance of an additional service activity, and/or a voucher or coupon for a complimentary product, additional service activity, to the end-user along the network 10 to the customer access portal 160, including without limitation, as an output on a software app on a mobile device 163 of the end-user that forms part of the customer access portal 160 or is coupled thereto.

In some non-limiting examples, an individual service activity record 240 may reflect the performance of a plurality of service activities and/or the use of a plurality of parts in such service activit(ies). In some non-limiting examples, an individual service activity record 240 may reflect the performance of a single service activity or the use of a single part in a service activity, with the POS electronic datum 200 comprising a plurality of such service activity records 240. In some non-limiting examples, there may be a separate POS electronic datum 200 for each such individual service activity record 240. Those having ordinary skill in the relevant art will appreciate that where individual service activit(ies) and parts each have an individual service activity record 240 associated therewith, irrespective of whether such individual service activity records 240 each have an individual POS electronic datum 200 associated therewith, the granularity of information that may be aggregated by the trend generator 130 therefrom, and/or the processing performed by the trend generator 130 to aggregate and maintain such information may be reduced, but at the cost of potentially increased data traffic between the POS AMMS 110, 120 associated with the POS datum generator 115 and the trend generator 130.

### Service Subcontractor

If present, the service subcontractor 140 accepts as input, outputs from the TDMP 112 and generates outputs to the TDMP 112 along the network 10.

By way of non-limiting example, the TDMP 112 may communicate with the service subcontractor(s) 140 along the network 10 to identify, order, to arrange for, and/or accept, delivery of and/or payment and/or invoicing of, one or more of the specified service activities, based on the information associated with the service activity to be performed, together with information associated therewith and/or derived therefrom, including without limitation, billing and/or credit information, as well as delivery information of the facility.

In some non-limiting examples, the service subcontractor 140 may form part of the same organization as the POS AMMS 110, 120 housing the TDMP 112, such that the inputs and outputs between the service subcontractor 140 and the TDMP 112 effect the delivery of the vehicle to the service subcontractor 140, performance of the specified subcontracted service(s) thereon and return of the vehicle to the POS AMMS 110, 120 housing the TDMP 112.

In some non-limiting examples, the service subcontractor 140 may form part of the same organization as the POS AMMS 110, 120 housing the TDMP 112, such that the inputs and outputs between the TDMP 112 effect the order and/or invoicing of such subcontracted service(s), in addition to the delivery of the vehicle to and from the service subcontractor 140 to the POS AMMS 110, 120 housing the TDMP 112 for, and the performance of the specific subcontracted service(s) thereon. In some non-limiting examples, the service subcontractor 140 may be independent of the POS AMMS 110, 120 housing the TDMP 112, such that the inputs and outputs effect the order and/or invoicing of such subcontracted service(s), in addition to the delivery of the vehicle to and from the service contractor 140 to the POS AMS 110, 120 housing the TDMP 112, for, and the performance of the specific subcontracted service(s) thereon.

### Parts Depot

If present, the parts depot 150 accepts as input, outputs from the POIP 113 and generates outputs to the POIP 113 along the network 10.

By way of non-limiting example, the POIP 113 may communicate with the parts depot 150 along the network 10 to identify, order, to arrange for, and/or accept, delivery of and/or payment and/or invoicing of, one or more parts that it does not have in stock, or for which it wishes to replenish its inventory. Such parts may, in some non-limiting examples, be related to one or more parts identified as being of use in the service activity to be performed on the vehicle.

In some non-limiting examples, the parts depot 150 may form part of the same organization as the POS AMMS 110, 120 housing the POIP 113, such that the inputs and outputs between the parts depot 150 and the POIP 113 affect the delivery of one or more parts from the parts depot 150 to the POS AMMS 110, 120. In some non-limiting examples, the parts depot 150 may be independent of the POS AMMS 110, 120 housing the POIP 113, such that the inputs and outputs between the POIP 113 affect the order and/or invoicing of such parts, in addition to their delivery from the parts depot 150 to the POS AMMS 110, 120.

### Customer Access Portal

If present, the customer access portal 160, which in some non-limiting examples, may comprise and/or be implemented by or in one or more software or other processing and/or algorithmic modules, comprises at least one I/O device by which an end-user may provide inputs to and/or receive outputs from the system 100 along the network 10. Such I/O device may be any one or more of, without limitation, a display 161, a data input device (not shown), which may or may not be combined with the display 161, a printer 162 and/or a mobile device 163 such as a smartphone.

In some non-limiting examples, the I/O device may be a component of the customer access portal 160. In some non-limiting examples, the I/O device may be coupled to the customer access portal 160, whether directly or indirectly through a bus, a network interface and/or an I/O interface.

In some non-limiting examples, where the I/O device is a mobile device 163, the mobile device 163 may comprise a software application (“app”) specific to the system 100 whereby inputs may be provided to one or more AMMS 110, 120 and/or to a VIP 111 thereof, and/or whereby outputs may be received from one or more AMMS 110, 120 and/or from any one or more of: a VIP 111 and/or a POS datum generator 115 thereof and/or from any one or more of the trend generator(s) 130.

In some non-limiting examples, the customer access portal 160 and/or a software app on a mobile device 163 associated therewith may be used to request a report request from the trend generator(s) 130 and to receive a report responsive thereto.

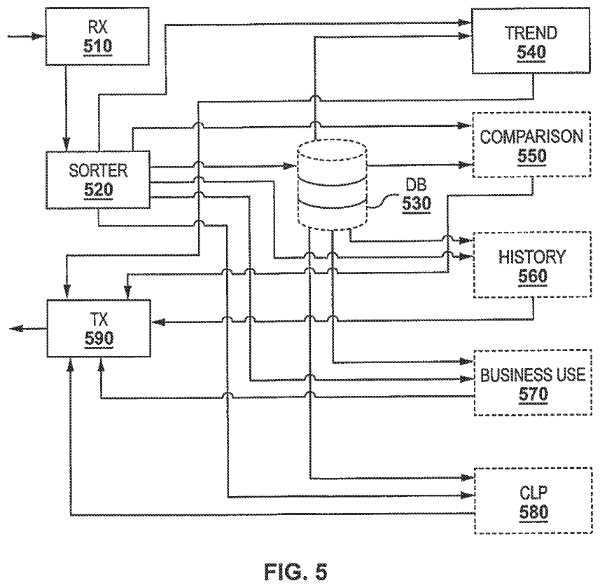

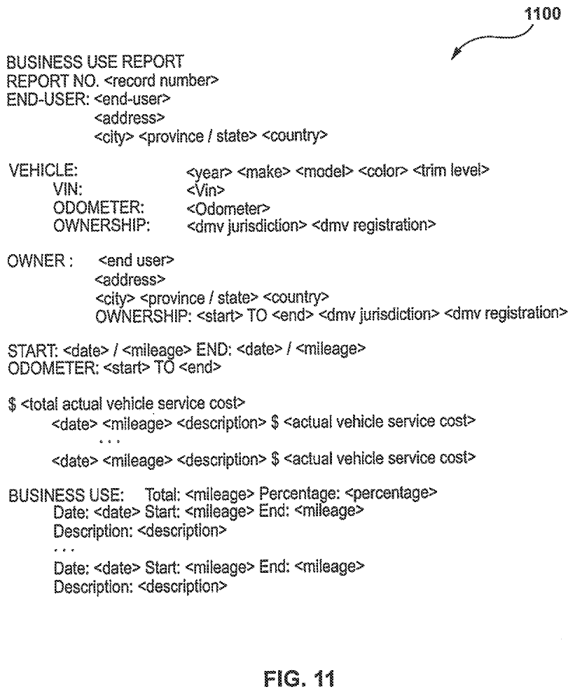

In some non-limiting examples, where the trend generator(s) 130 is/are configured with a business use calculator 570 (FIG. 5), the customer access portal 160 and/or a software app on a mobile device 163 associated therewith may be used to generate and communicate at least one use datum (not shown) to the trend generator(s) 130 from which a business use category report 1100 (FIG. 11) may be prepared. In some non-limiting examples, each such use datum may include a unique identifier (such as, without limitation, the VIN) of a vehicle, an end-user, date, a time, an origin, a destination, a categorization and/or a description of the use represented by such use datum. In some non-limiting examples, existing time and/or date functions of the mobile device 163 may automatically populate the date and/or time fields of such datum such as, without limitation, when prompted by an input from the end-user on the mobile device 163. In some non-limiting examples, existing GPS and/or navigation functions of the mobile device 163 may automatically populate the origin and/or destination fields of such datum, such as, without limitation, when prompted by an input from the end-user on the mobile device 163.

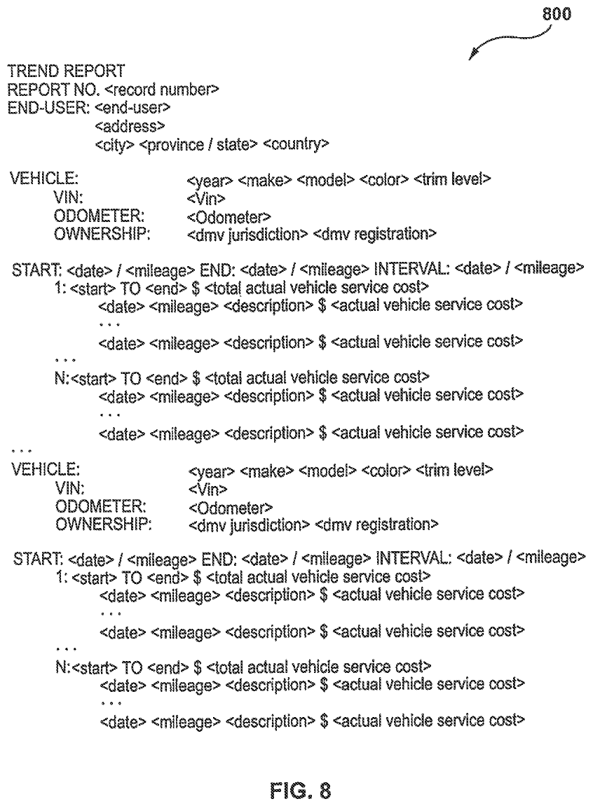

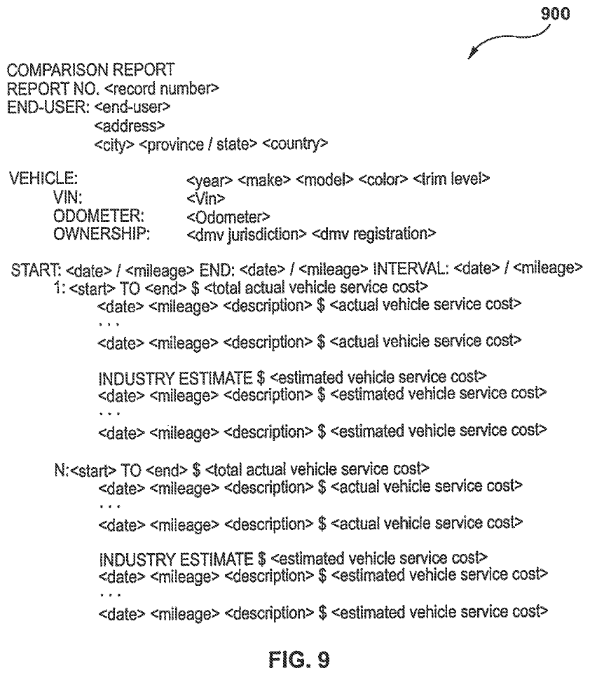

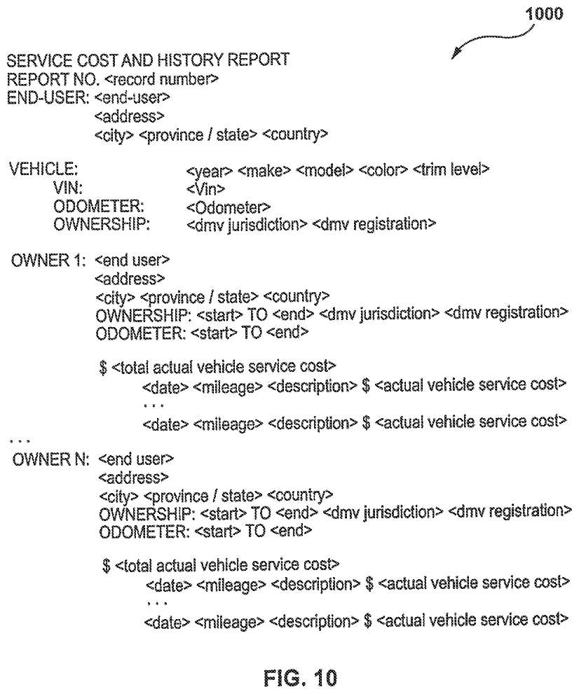

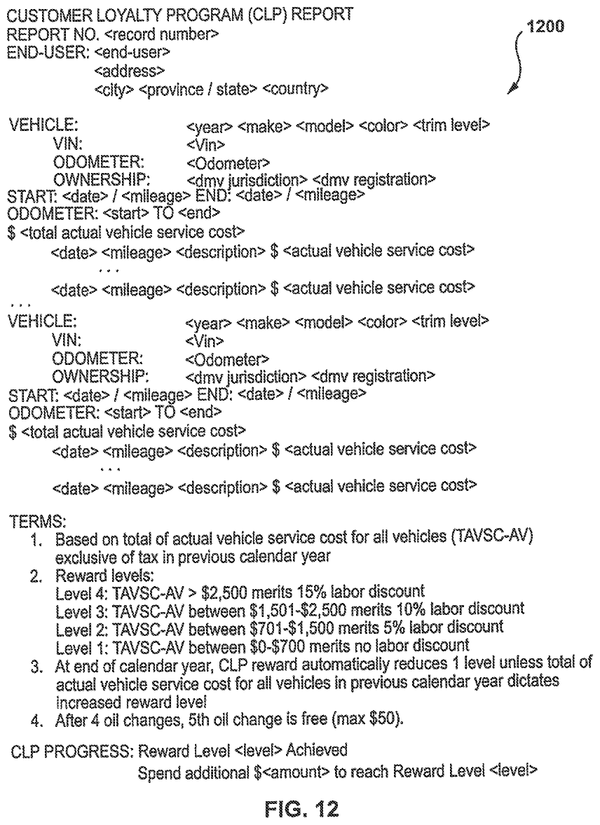

In some non-limiting examples, outputs received on such app may comprise, without limitation, an electronic POS datum 200 (FIG. 2) from the POS datum generator 115, as discussed above, a CLP entitlement datum 1300 (FIG. 13), and/or a report responsive to a report request, from the trend generator 130, as discussed below. Such a report may comprise, without limitation, a trend report 800 (FIG. 8), a comparison report 900 (FIG. 9), a history report 1000 (FIG. 10), a business use category report 1100 (FIG. 11) and/or a CLP entitlement report 1200 (FIG. 12).

DMV Registry

As discussed previously, in some non-limiting examples, the definition of “facility” may be extended to encompass a DMVR, such that the concept of service costs may be extended to encompass all costs associated with the vehicle including the costs incurred by an end-user to obtain the vehicle and then to maintain its annual registration.

In such scenarios, the DMVR 170, which in some non-limiting examples, may comprise and/or be implemented by or in one or more software or other processing and/or algorithmic modules, accepts as input, requests from the trend generator(s) 130 for information associated with at least one of an end-user and/or a vehicle thereof. Upon receiving such request, the DMVR 170 generates as output (in some non-limiting examples, in the form of a variant of a POS electronic datum 200, in some non-limiting examples comprising a vehicle record 230 but being substantially devoid of any service activity record 240) containing up-to-date (and in some non-limiting examples, historical) information concerning vehicles registered with the DMV by the end-user and/or end-users who have registered a given vehicle with the DMV.

In some non-limiting examples, the DMVR 170 may, in turn, present a request for a history report 1000 (FIG. 10) to the trend generator(s) 130 and receive a history report 1000 (FIG. 10) responsive thereto.

### Trend Generator

The trend generator 130, which in some non-limiting examples, may comprise and/or be implemented by or in one or more software or other processing and/or algorithmic modules, accepts as input, at least one POS electronic datum 200 from the POS datum generator 115 of at least one POS AMMS 110, 120 associated therewith in respect of a given service activity for a given vehicle for a given end-user at a facility associated with the POS AMMS 110, 120.

As well, as indicated previously, there may be a plurality of trend generators 130 associated with a given POS AMMS 110, 120, and/or there may be a plurality of POS AMMS 110, 120 associated with a given trend generator 130.

Those having ordinary skill in the relevant art will appreciate that even for a given trend generator 130, a given POS AMMS 110, 120 will typically provide service activities for a plurality of end-users, and that POS electronic data 200 may be provided to the trend generator(s) 130 associated therewith for service activities for each such end-user.

Those having ordinary skill in the relevant art will further appreciate that a given end-user may have a plurality of vehicles that the end-user will typically bring to such POS AMMS 110, 120 for at least one service activity. Thus, POS electronic data 200 may be provided to the trend generator(s) 130 associated therewith for service activities for each such vehicle, for each such end-user.

Those having ordinary skill in the relevant art will also appreciate that over the course of time, the end-user will typically bring such a vehicle to such POS AMMS 110, 120 for a variety of service activities. Thus, POS electronic data 200 may be provided to the trend generator(s) 130 associated therewith for each such service activity for each such vehicle, for each such end-user.

Those having ordinary skill in the relevant art will also appreciate that a given end-user may not exclusively use a given POS AMMS 110, 120 exclusively for providing service activities for a given vehicle. Indeed, the end-user may employ a variety of POS AMMS 110, 120, depending upon a number of factors, including without limitation, the geographic location of the vehicle and the various POS AMMS 110, 120 (including, without limitation, because the vehicle may be away from its regular location at the time of the desired service activity), the date of the service activity (including, without limitation, because the end-user may have moved in the interim, because of a warranty claim or because warranty coverage has expired), the nature of the service activity (including, without limitation, whether the service activity is preventative, periodic or as a result of an accident).

Thus, provided that the various POS AMMS 110, 120 have associated therewith the same trend generator 130, POS electronic data 200 may be provided to the trend generator(s) 130 associated therewith for service activities from a plurality of the various POS AMMS 110, 120, for each such service activity, for each such vehicle, for each such end-user.

Even if one of such various POS AMMS 110, 120 is not associated with the same trend generator 130, there may be established a sharing mechanism between various trend generators 130 such that one or more trend generator(s) 130 associated with such POS AMMS 110, 120 (sharing trend generator 130) may forward POS electronic data 200 from such POS AMMS 110, 120 to one or more trend generator(s) 130 (receiving trend generator 130) that are associated with the other POS AMMS 110, 120, such that the POS electronic data 200 associated with a given vehicle and/or a given end-user may be compiled by a (compiling) trend generator 130, even if the service activity is not solely performed by POS AMMS 110, 120 associated with the compiling trend generator 130.

As a result of the foregoing, it will be appreciated that a large number of POS electronic data 200 may be provided by a variety of POS AMMS 110, 120 to a variety of trend generators 130 over time, associated with a plurality of vehicles and their associated end-users.

Still further, as discussed above, in some non-limiting examples, a form of POS electronic data 200 may be provided by a DMVR 170 to the trend generator(s) 130 in response to a request therefor.

All of the electronic data referenced in the preceding paragraphs are considered POS electronic data 200, in that they were generated by the DMVR 170 and/or a POS datum generator 115 housed within a POS AMMS 110, 120 associated with the facility where the service activity, which forms the basis of such invoice, was performed and substantially contemporaneously therewith.

It will be appreciated that for a variety of reasons, including without limitation, where at least one non-electronic, hard copy or paper invoice associated with a given vehicle and a given end-user was obtained, without corresponding POS electronic data 200 being communicated to a trend generator 113 associated therewith (such as where the service activity was performed at a facility that is not associated with the system 100 and/or the service activity was provided before the system 100 was established), there may be invoices that are not considered POS electronic data 200 capable of being communicated to a trend generator 113.

In such instances, such non-POS data may be provided to the trend generator 130 by manual transcription and entry of relevant data into at least one transcribed electronic datum (not shown) by, without limitation, service personnel (not shown) at an I/O device (not shown) that may be coupled to any one or more of: the trend generator 130, and/or the POS AMMS 110, 120 associated therewith, whether directly or indirectly through a bus, a network interface and/or an I/O interface. In some non-limiting examples, an end-user (not shown) may manually transcribe and enter relevant data into at least one transcribed electronic datum (not shown) at an I/O device (not shown) that may be coupled to the customer access portal 160, whether directly or indirectly through a bus, a network interface and/or an I/O interface, provided that security measures are implemented to preclude malicious provision of false information by the end-user. In some non-limiting examples, such security measures may be implemented to preclude malicious provision of false information, even if the manual transcription is performed by service personnel (not shown) at an I/O device (not shown) coupled to any one or more of: the trend generator 130, and/or the POS AMMS 110, 120 associated therewith, whether directly or indirectly through a bus, a network interface and/or an I/O interface.

In some non-limiting examples, the trend generator 130 may confirm that security measures have been taken to preclude provision of false information in the at least one transcribed electronic datum (not shown). In some non-limiting examples, such security measures may be provided by the trend generator 130 when the at least one transcribed electronic datum (not shown) is received by it. In some non-limiting examples, such security measures may be provided when the transcription is performed.

It will be further appreciated that such manual transcription and entry of relevant data from such non-POS data may introduce transcription and/or other errors into the process, which may not be present in the case of POS electronic data 200 and which may not reflect the actual costs of service activities provided to a given vehicle of a given end-user. Such errors may include, without limitation, errors in any one or more of the date, cost, description of the service activity, identity of the POS AMMS 110, 120, identity of the vehicle for which the service activity was provided and/or identity of the end-user of the vehicle.

In any event, however many and in what fashion they are accumulated, over time, there will be accumulated by a trend generator 130, a plurality of data points corresponding to actual vehicle costs of service activities provided to a given vehicle of a given end-user.

The trend generator 130 processes such data points and generates, in response to a trend report request, a trend report 800 (FIG. 8) comprising at least one trend of the actual vehicle service costs as a function of a trend parameter, such as, without limitation, date, time and/or accumulated mileage, for at least one vehicle and/or at least one end-user thereof.

In some non-limiting examples, the trend generator 130 uses the at least one trend and/or the underlying processed data points to provide, in response to a comparison report request, a comparison report 900 (FIG. 9) comprising a comparison of the actual vehicle service costs over a period of time and/or a mileage range against industry estimates of vehicle service costs.

In some non-limiting examples, the trend generator 130 uses the at least one trend and/or the underlying processed data points to provide, in response to a history report request, a history report 1000 (FIG. 10) comprising a detailed service cost and repair history report for the vehicle.

In some non-limiting examples, the trend generator 130 uses the at least one trend and/or the underlying processed data points to provide, in response to a business use category report 1100 (FIG. 11) comprising a substantially automated calculation of business use of a vehicle.

In some non-limiting examples, the trend generator 130 uses the at least one trend and/or the underlying processed data points to implement a CLP at the level of any one or more of: a facility, one or more facilities in a chain of facilities, all facilities associated with the trend generator 130 and/or all facilities in the system 100 and to provide, in response to a CLP entitlement report request, a CLP entitlement report 1200 (FIG. 12) outlining accrued and/or partially accrued CLP entitlements for the end-user.

The trend generator 130 may provide such reports, as appropriate, to any one or more of: the customer access portal 160 (and/or a software app on a mobile device 163 associated therewith), the POS datum generator 115 of a POS AMMS 110, 120 (including, without limitation, the POS AMMS 110, 120 that provided the most recent POS electronic data 200), the TDMP 112 and/or the accounting processor 114 of such POS AMMS 110, 120, and/or the DMVR 170.

FIG. 5 is an example simplified block diagram of a trend generator 130. The trend generator 130 comprises a receiver 510, a sorter 520, a trend engine 540 and a transmitter 580. In some non-limiting examples, the trend generator 130 may comprise a data repository or database 530. In some non-limiting examples, the trend generator 130 may comprise a comparator 550, a historian 560, a business use calculator 570 and/or a customer loyalty administrator 580.

Receiver

The receiver 510, which in some non-limiting examples, may comprise and/or be implemented by or in one or more software or other processing and/or algorithmic modules, accepts each of the POS electronic data 200 from the POS datum generator 115 of any of the POS AMMS 110, 120 associated with the trend generator 130, as well as shared POS electronic data 200 from a sharing trend generator 130 and/or modified POS electronic data 200 from the DMVR 170.

Further, the receiver 510 accepts each of the transcribed electronic data (not shown) from, without limitation, an end-user (not shown) and/or service personnel (not shown) at an I/O device (not shown) that may be coupled to any one or more of: the trend generator 130, the POS AMMS 110, 120 associated therewith and/or a customer access portal 160, whether directly or indirectly through a bus, a network interface and/or an I/O interface.

In some non-limiting examples, the receiver 151 may provide security measures to preclude malicious provision of false information on behalf of the trend generator 130.

Additionally, the receiver 510 accepts use data (not shown) from a customer access portal 160 and/or a software app on a mobile device 163 associated therewith.

Still further, the receiver 510 accepts report requests from the customer access portal 160 and/or a software app on a mobile device 163 associated therewith, the DMVR 170 and/or an end-user whether or not at a customer access portal 160. Without limitation, such a report request from an end-user may be communicated to service personnel and entered at an I/O device (not shown) coupled, whether directly or indirectly through a bus, a network interface and/or an I/O interface to the VIP 111, TMDP 112, POIP 113, accounting processor 114 and/or the POS datum generator 115 of an AMMS 110, 120, or even at an I/O device (not shown) coupled to the trend generator 130, whether directly or indirectly through a bus, a network interface and/or an I/O interface.

FIG. 6 is an example format of a report request 600. In some non-limiting examples the report request 600 comprises a unique record number 610, a date 620 and/or a time 621 that the report request 600 was created, values representing a source of the requesting entity 622 a request type 623, a vehicle record 630, an indication whether the report is in respect of the vehicle or the end-user thereof 640, and/or at least one parameter of the request 650. In some non-limiting examples, the vehicle record 630 may be substantially the same as the vehicle record 230 set out in FIG. 3.

The receiver 510 forwards all received report requests and data to the sorter 520 upon receipt.

### Sorter

The sorter 520, which in some non-limiting examples, may comprise and/or be implemented by or in one or more software or other processing and/or algorithmic modules, accepts from the receiver 510 all received report requests and data and redirects them to an appropriate destination.

In the case of a report request, the sorter 520 forwards the request to an appropriate one of the trend engine 540 and/or the comparator 550, the historian 560, the business use calculator 570 and/or the customer loyalty administrator 580.

In the case of a POS electronic datum 200, a modified POS electronic datum 200 and/or a transcribed electronic datum (not shown), the sorter 520 stores such data, indexed by the unique identifier, which may be, without limitation, the VIN, as well as by a value of a trend parameter, such as, without limitation, a date as referenced by a record date 220, 230, 240, time 221, 231, 241 and/or accumulated mileage of the vehicle as shown on the odometer 330, 430, for easy retrieval by the trend engine 540, the comparator 550, the historian 560, the business use calculator 570 and/or the customer loyalty administrator 580. In some non-limiting examples, the sorter 520 stores such data in the data repository 530.

In the case of a use datum (not shown), the sorter 520 stores such data, indexed by the unique identifier, which may be without limitation, the VIN, as well as by a value of a trend parameter, such as, without limitation, a date as referenced by a record date 220, 230, 240, time 221, 231, 241 and/or accumulated mileage of the vehicle as shown on the odometer 330, 430, for easy retrieval by the business use calculator 570. In some non-limiting examples the sorter 520 stores such data in the data repository 530.

### Data Repository

If present, the data repository 530 stores data provided by the sorter 520, including without limitation, a POS electronic datum 200, a modified POS electronic datum 200 and/or a transcribed electronic datum (not shown), indexed by the unique identifier, which may be, without limitation, the VIN, as well as by a value of a trend parameter, such as, without limitation, a date as referenced by a record date 220, 230, 240, time 221, 231, 241 and/or accumulated mileage of the vehicle as shown on the odometer 330, 430, for easy retrieval by the trend engine 540, the comparator 550, the historian 560, the business use calculator 570 and/or the customer loyalty administrator 580, and/or a use datum (not shown), indexed by the unique identifier, which may be without limitation, the VIN, as well as by a value of a trend parameter, such as, without limitation, a date as referenced by a record date 220, 230, 240, time 221, 231, 241 and/or accumulated mileage of the vehicle as shown on the odometer 330, 430, for easy retrieval by the business use calculator 570.

### Transmitter

The transmitter 590 receives trend reports from the trend engine 540, comparison reports from the comparator 550, history reports from the historian 560, business use category reports 570 from the business use calculator 580 and outputs to the customer access portal 160 and/or a software app on a mobile device 163 associated therewith, the DMVR 170 and/or an end-user whether or not at a customer access portal 160, responsive to a report request therefrom.

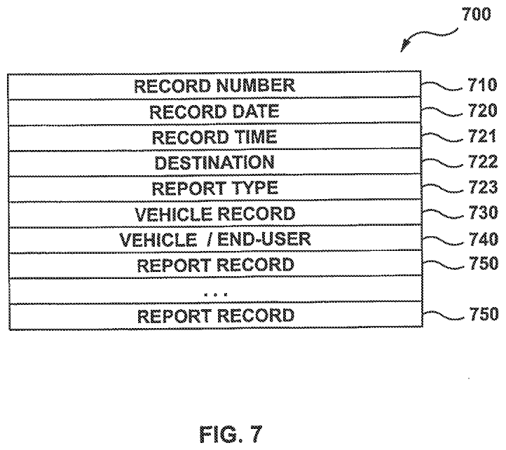

FIG. 7 is an example format of a report 700. In some non-limiting examples the report 700 comprises a unique record number 710, a date 720 and/or a time 721 that the report 700 was created, values representing a destination of the requesting entity 722 a report type 723, a vehicle record 730, an indication whether the report is in respect of the vehicle or the end-user thereof 740, and/or at least one report record 750. In some non-limiting examples, the vehicle record 730 may be substantially the same as the vehicle record 230 set out in FIG. 3.

Additionally, the transmitter 590 issues requests to the DMVR 170 for information associated with at least one of an end-user and/or a vehicle thereof.

### Trend Engine

The trend engine 540, which in some non-limiting examples, may comprise and/or be implemented by or in one or more software or other processing and/or algorithmic modules, receives a trend report request from the sorter 520, and processes the request 600 to identify the vehicle, whether the report is in respect of the vehicle specified or all vehicles of the associated end-user, and to determine relevant parameters thereof. In some non-limiting examples, one of the parameters is identification of the trend parameter. In some non-limiting examples, one of the parameters is a range of the trend parameter across which the at least one trend is to be compiled. In some non-limiting examples, one of the parameters is an interval into which the range is to be apportioned.

The trend engine 540 generates at least one trend of the actual vehicle service costs as a function of a trend parameter, such as, without limitation, date, time and/or accumulated mileage, for at least one vehicle and/or at least one end-user thereof for prepares a trend report 800 therefrom, that it forwards to the transmitter 590 in the form of a report 700.

In some non-limiting examples, the at least one trend corresponds to all and/or a subset of vehicles of a given end-user. In some non-limiting examples, the at least one trend corresponds to an individual vehicle.

In some non-limiting examples, the at least one trend is provided in text foam. In some non-limiting examples, the at least one trend is provided in graphical form. In some non-limiting examples, the at least one trend is provided in tabular form.

In some non-limiting examples, the trend parameter is a date. In some non-limiting examples, the trend parameter is an accumulated mileage.

In some non-limiting examples, the range begins at a value of the parameter at an initial event and ends at a final event.

In some non-limiting examples, the initial event is when the end-user obtained the vehicle and/or when a previous end-user obtained the vehicle, including from a new car dealer. In some non-limiting examples, the initial event is a beginning of a calendar year, a beginning of a fiscal year for the end-user, an initial service activity performed on the vehicle, a mileage threshold of the vehicle and/or a significant event of the end-user, including without limitation, a birthday or anniversary. Non-limiting examples of a mileage threshold includes multiples of 100,000 miles, 50,000 miles, 20,000 miles, 10,000 miles, 5,000 miles, 2,000 miles 1,000 miles, 500 miles, 250 miles, 100 miles, 50 miles, 200,000 km, 100,000 km, 50,000 km, 20,000 km, 10,000 km, 5,000 km, 2,000 km, 1,000 km, 500 km, 250 km and/or 100 km.

In some non-limiting examples, the final event is the generation of the trend report request.

In some non-limiting examples, when the trend parameter is a date, the interval is any one or more of a range of consecutive years, a year, a half-year, a quarter, a trimester and/or a month. In some non-limiting examples, when the trend parameter is an accumulated mileage, the interval is any one or more of 100,000 miles, 50,000 miles, 20,000 miles, 10,000 miles, 5,000 miles, 2,000 miles, 1,000 miles, 500 miles, 250 miles, 100 miles and/or 50 miles, 200,000 km, 100,000 km, 50,000 km 20,000 km, 10,000 km, 5,000 km, 2,000 km, 1,000 km, 500 km, 250 km and/or 100 km.

In some non-limiting examples, one of the parameters is an attribute to be extracted from the data in each interval to create the at least one trend. In some non-limiting examples, the attribute is at least one of a total, average and/or median actual service cost, a number of service appointments, a category and/or type of a service activity, a total, average and/or duration of a service activities, a number of days in a service facility (“out of service), and/or a number of unit hours incurred in a service activity.

However, so constituted, each such at least one trend may be generated on a system-wide basis, on the basis of a chain of associated facilities, including without limitation, a dealer network or a network of franchises or locations of a service operation, or on the basis of an individual or a list of specified facilities.

With such parameters, the trend engine 540 orders all data associated therewith. Where the request is in respect of the specified vehicle, such data comprises all data indexed by the unique identifier of the vehicle and having a trend parameter that falls between the initial and final event. Where the request is in respect of the end-user of the specified vehicle, such data comprises all data indexed by a unique identifier of the vehicle that is identified as being obtained by the end-user of the specified vehicle, which includes the specified vehicle, and having a trend parameter that falls within the initial and final event.

This data is ordered according to the unique identifier of the vehicle and then by in order of the value of the trend parameter.

Once ordered, the data is divided into sets corresponding to successive intervals within the range (for each vehicle) based on the value of the trend parameter associated with each datum.

Finally, for each set of data, the specified attribute is extracted from the set to create the trend.

An example of a trend report 800 is shown in FIG. 8. In some non-limiting examples, it lists the report number, the information related to the end-user and the information related to the vehicle(s) associated with the end-user.

For each vehicle, in some non-limiting examples, the unique identifier, odometer reading and/or current DMV registration information is provided. In some non-limiting examples, the initial and final point of the specified range and/or the specified interval is set out.

Thereafter, in some non-limiting examples, each data set corresponding to successive intervals is set out, showing the range thereof and the attribute extracted therefrom (in the example, a total actual vehicle service cost). In some non-limiting examples, a description of each datum comprising the data set is set out for reference.

Thus, the trend generator 130, including the trend engine 540 thereof, may provide a mechanism, whether for an individual facility or across a plurality of facilities, whether or not part of a common organization, to provide a reasonably accurate and/or reliable assessment of actual vehicle service costs incurred by an end-user and/or for a given vehicle of an end-user. This may allow the end-user to make decisions on whether, and/or when to obtain a different vehicle, based on real, as opposed to anecdotal information, and to make a reasoned decision, if desired, to obtain such vehicle at an optimal time, based on the actual trend of vehicle service costs incurred by the particular vehicle.

The ability to amass actual, validated vehicle service cost data from a wide variety of facilities, at the POS of such facilities, may greatly reduce the work involved in manual or even automatic transcription of printed invoices in generating such trends. Where such manual or automatic transcription of printed invoices is called for, typically for a small number of outlying service appointments where the POS data generation is not available, security measures may be implemented to preclude the malicious provision of false information by the end-user or otherwise, thus ensuring that the trend is based on validated data.

Further, the ability of the trend generator 130, including the trend engine 540 thereof, to generate such trends, including without limitation, the trend report 800 (FIG. 8), based on a wide variety of parameter combinations, including, without limitation, choice of trend parameter, choice of initial event and/or final event of a range, choice of interval into which the range would be apportioned, and/or choice of the attribute to be extracted, allows for considerable flexibility in the trend being generated and allows for detailed analysis of the aggregated electronic data reflected thereby with considerable granularity and for a wide variety of purposes.

Beyond such advantages for an end-user of such facility, the ability of a facility, whether on its own or across a plurality of facilities, whether or not part of a common organization, to provide such trends, reports and/or capabilities, may be beneficial in marketing its service activities to potential end-users thereof.

### Comparator

In some non-limiting examples, the comparator 550, which in some non-limiting examples, may comprise and/or be implemented by or in one or more software or other processing and/or algorithmic modules, receives a comparison report request from the sorter 520 and processes the request 600 to identify the vehicle, whether the report is in respect of the vehicle specified or all vehicles of the associated end-user, and relevant parameters thereof. In some non-limiting examples, the comparison report request will be in respect of the vehicle specified only.

The comparator 550 may provide a juxtaposition of the at least one trend and/or the underlying ordered data of the actual vehicle service costs for at least one data set corresponding to an interval against an industry estimate of vehicle service costs, that it forwards to the transmitter 590 in the form of a report 700.

An example of a comparison report 900 is shown in FIG. 9. In some non-limiting examples, it lists the report number, the information related to the end-user and the information related to the vehicle(s) associated with the end-user.

For each vehicle, in some non-limiting examples, the unique identifier, odometer reading and/or current DMV registration information is provided. In some non-limiting examples, the initial and final point of the specified range and/or the specified interval is set out.

Thereafter, in some non-limiting examples, each data set corresponding to successive intervals is set out, showing the range thereof and the attribute extracted therefrom (in the example, a total actual vehicle service cost). In some non-limiting examples, a description of each datum comprising the data set is set out for reference. In some non-limiting examples, this is followed by similar information taken from the industry estimate.

Thus, the existence of such validated data amassed, largely automatically, at the POS of service facilities and/or the DMVR 170, allows for the generation, by the trend generator 130, including the comparator 550 thereof, of a comparison of the costs actually incurred in the maintenance of a given vehicle relative to industry estimates of average vehicle service costs for a corresponding geographical region, time period, and/or vehicle type, model, mileage and/or age, including, without limitation, the comparison report 900 (FIG. 9). The automatic generation of such comparison allows a current end-user to provide full and validated disclosure of the present condition of the vehicle, which would be advantageous when attempting to transfer the vehicle to a subsequent end-user relative to other vehicles that the subsequent end-user is contemplating obtaining, that do not have such comparison.

Indeed, the amassing of such validated data across a wide range of facilities, geographical regions, time period and/or vehicle type, model, mileage and/or age by the trend generator 130 permits the determination, by the trend generator 130 itself, including the comparator 550 thereof, of detailed, accurate and reliable industry estimates of average vehicle service costs, that are superior from conventional industry estimates that are presently available.

Still further such data may allow a facility, who is contributing such validated data to the trend generator 130, including the comparator 550 thereof, to generate a comparison of its average vehicle service costs relative to such industry estimates, which may be beneficial in marketing its service activities to potential end-users thereof.

By way of non-limiting example, conventionally, if an end-user brings a vehicle to a pre-owned vehicle dealer for trade-in, such vehicle may be categorized by the dealer as being in a top (above-average), middle (average) or bottom (below-average) tier of vehicles for a given vehicle year, mileage, model and/or age, which may suggest offering a premium and/or a reduction in an average trade-in value of such vehicle, and/or in an average resale price for such vehicle when obtained by a subsequent end-user. Such categorization is typically done ad hoc, after only a cursory inspection of the vehicle, and depends to a greater or lesser degree upon the experience of the person performing such inspection. With some non-limiting examples of the present system and/or method disclosed herein, such report may provide a reasoned basis for making such categorizations and indeed, may allow for such categorizations and the resulting valuations, to be much more granular and accurate.

Beyond such advantages for an end-user of such facility, the ability of a facility, whether on its own or across a plurality of facilities, whether or not part of a common organization, to provide such reports and/or capabilities, may be beneficial in marketing its service activities to potential end-users thereof.

### Historian

In some non-limiting examples, the historian 560, which may comprise and/or be implemented by or in one or more software or other processing and/or algorithmic modules, receives a history report request from the sorter 520 and processes the request 600 to identify the vehicle, whether the report is in respect of the vehicle specified or all vehicles of the associated end-user, and relevant parameters thereof. In some non-limiting examples the history report request will be in respect of the vehicle specified only.

The historian 560 uses the at least one trend and/or the underlying processed data points to provide a detailed service cost and repair history report of the vehicle specified that it forwards to the transmitter 590 in the form of a report 700.

An example of a history report 1000 is shown in FIG. 10. In some non-limiting examples, it lists the report number, the information related to the end-user and the information related to the vehicle(s) associated with the end-user.

For each vehicle, in some non-limiting examples, the unique identifier, odometer reading and/or current DMV registration information is provided.

In some non-limiting examples, the information related to each successive end-user of the vehicle is listed, showing an initial and final point in terms of a trend parameter corresponding to the range during which the vehicle was obtained by such end-user.

Thereafter, in some non-limiting examples, each data set corresponding to the range during which the vehicle was obtained by such end-user is set out, showing the range thereof and the attribute extracted therefrom (in the example, a total actual vehicle service cost). In some non-limiting examples, a description of each datum comprising the data set is set out for reference.

Thus, in some non-limiting examples the existence of such validated data amassed, largely automatically, at the POS of service facilities and/or the DMVR 170, may allow for the generation of official reports, detailing the accident history of such vehicles. As opposed to such conventional accident history reports that are presently available, such reports generated by the trend generator 130, including the historian 560 thereof, including without limitation, the history report 1000 (FIG. 10), may provide, for example, full details of all service activities, including the actual vehicle service cost of service activities to repair the vehicle. Conventional accident history reports typically do not provide any vehicle service cost information. At most, such reports may provide a dollar value of an insurance payout to cover a given accident, but such insurance payout may be allocated to incidental damage to property occasioned by the accident, but which is not attributable to any service activity performed on the vehicle itself.

Still further, in some non-limiting examples, the existence of such validated data amassed, largely automatically, at the POS of service facilities and/or the DMVR 170, may allow for the generation, by the trend generator 130, including the historian 560 thereof, of a complete maintenance history of the vehicle, including, without limitation, the history report 1000 (FIG. 10), across multiple end-users. The automatic generation of such maintenance history may allow a current end-user to provide full and validated disclosure of the present condition of the vehicle, which would be advantageous when attempting to transfer the vehicle to a subsequent end-user relative to other vehicles that the subsequent end-user is contemplating obtaining, that do not have such maintenance history.

Additionally, in some non-limiting examples, the automatic generation of such maintenance history may allow a current end-user to provide full and validated disclosure of the nature and/or source of the service activities performed thereon, which may be relevant when considering if existing warranty coverage should extend to such activities and/or be maintained once such activities have been performed. In this regard, by way of non-limiting example, the identification of the facility that performed a given service activity may be relevant to such determination, given whether it is an authorized service facility under the warranty program.

By way of non-limiting example, conventionally, if an end-user brings a vehicle to a pre-owned vehicle dealer for trade-in, such vehicle may be categorized by the dealer as being in a top (above-average), middle (average) or bottom (below-average) tier of vehicles for a given vehicle year, mileage, model and/or age, which may suggest offering a premium and/or a reduction in an average trade-in value of such vehicle, and/or in an average resale price for such vehicle when obtained by a subsequent end-user. Such categorization is typically done ad hoc, after only a cursory inspection of the vehicle, and depends to a greater or lesser degree upon the experience of the person performing such inspection. With some non-limiting examples of the present system and/or method disclosed herein, such report may provide a reasoned basis for making such categorizations and indeed, may allow for such categorizations and the resulting valuations, to be much more granular and accurate.

Beyond such advantages for an end-user of such facility, the ability of a facility, whether on its own or across a plurality of facilities, whether or not part of a common organization, to provide such reports and/or capabilities, may be beneficial in marketing its service activities to potential end-users thereof.

### Business Use Calculator

In some non-limiting examples, the business use calculator 570, which in some non-limiting examples, may comprise and/or be implemented by or in one or more software or other processing and/or algorithmic modules, receives a business use category report request from the sorter 520 and processes the request 600 to identify the vehicle, whether the report is in respect of the vehicle specified or all vehicles of the associated end-user, and relevant parameters thereof. In some non-limiting examples the business use category report request will be in respect of the vehicle specified only.

The business use calculator 570 uses the at least one trend and/or the underlying processed data points to provide a substantially automated mechanism for calculating business use of the vehicle specified that it forwards to the transmitter 590 in the form of a report 700.

An example of a business use category report 1100 is shown in FIG. 11. In some non-limiting examples, it lists the report number, the information related to the end-user and the information related to the vehicle(s) associated with the end-user.

For each vehicle, in some non-limiting examples, the unique identifier, odometer reading and/or current DMV registration information is provided.

In some non-limiting examples, the information related to the end-user of the vehicle is listed, showing an initial and final point in terms of a trend parameter corresponding to the range for which the categorization is to be determined.

Thereafter, in some non-limiting examples, the data set corresponding to the range is set out, showing the range thereof and the attribute extracted therefrom (in the example, a total actual vehicle service cost). In some non-limiting examples, a description of each datum comprising the data set is set out for reference.

Finally, in some non-limiting examples, a calculated mileage, expressed as a total business use mileage and a percentage of the total mileage represented thereby is set, based on the categorization in each of the use data corresponding to the specified range. In some non-limiting examples, a description of each use datum comprising the data set is set out for reference.

Thus, in some non-limiting examples, the existence of such validated data amassed, largely automatically, at the POS of service facilities and/or the DMVR 170, may allow for the generation, by the trend generator 130, including the calculator 570 thereof, of a calculation of the costs actually incurred in the maintenance of a given vehicle attributable to business (or some other category of) use, including, without limitation, the business use report 1100 (FIG. 11). The automatic generation of such use report allows a current end-user to provide full and validated disclosure of the business use of the vehicle, which would be advantageous when attempting to justify business (or some other category of) use of the vehicle and the deductibility and/or other categorization of the actual service costs of the vehicle.

Beyond such advantages for an end-user of such facility, the ability of a facility, whether on its own or across a plurality of facilities, whether or not part of a common organization, to provide such reports and/or capabilities, may be beneficial in marketing its service activities to potential end-users thereof.

### Customer Loyalty Administrator

In some non-limiting examples, the customer loyalty administrator 580, which in some non-limiting examples, may comprise and/or be implemented by or in one or more software or other processing and/or algorithmic modules, receives a CLP report request from the sorter 520 and processes the request 600 to identify the vehicle, whether the report is in respect of the vehicle specified or all vehicles of the associated end-user, and relevant parameters thereof. In some non-limiting examples, the CLP report request will be in respect of all vehicles of the associated end-user.

The customer loyalty administrator 580 implements a CLP at the level of any one or more of: a facility, one or more facilities in a chain of facilities, all facilities associated with the trend generator 130 and/or all facilities in the system 100.

Such CLP may be defined in terms of a series of tiered thresholds of actual accumulated service costs, each threshold corresponding to an associated benefit that is awarded.

The customer loyalty administrator 580 uses the at least one trend and/or the underlying processed data points to determine entitlements for the associated end-user under the CLP, awarding such entitlements when at least one threshold of the CLP is exceeded by a feature of the accumulated data points and to provide a report thereof that it forwards to the transmitter 590 in the form of a report 700.

Such CLP may extend at the level of an individual POS AMMS 110, 120 or may extend at a broader level, including, without limitation, encompassing all POS AMMS 110, 120 of a given chain of associated facilities, including without limitation, a dealer network or a network of franchises or locations of a service operation and even beyond. Further, such CLP may relate to a given vehicle or to all vehicles of a given end-user.

Still further, such CLP may be dynamically adjustable and made as simple or as complex as desired.

Such entitlement may comprise, without limitation, a rebate on past service activity, a complimentary product (including without limitation, a snow scraper, floor mats, and/or an air freshener), an additional service activity (including without limitation, a car wash or detailing, tire storage and/or free oil change) to be performed on a complimentary basis and/or a discount on future service activity.

In some non-limiting examples, the customer loyalty administrator 580 determines that the vehicle and/or the end-user thereof has accrued at least one entitlement under such CLP and generates outputs to communicate such entitlement to at least one of the TDMP 112 associated with a POS AMMS 110, 120 (including, without limitation, the POS AMMS 110, 120 that provided the most recent POS electronic data 200) and/or the end-user along the network 10 to the customer access portal 160, including without limitation, as an output on a software app on a mobile device 163 of the end-user that forms part of the customer access portal 160 or is coupled thereto.

In some non-limiting examples, the customer loyalty administrator 580 communicates such entitlement, in the form of an additional service activity to be performed, to the TDMP 112, whereupon such additional service activity can be scheduled and performed while the vehicle is at the POS AMMS 110, 120.

In some non-limiting examples, the customer loyalty administrator 580 communicates such entitlement, in the form of a funds transfer (in the case of a rebate) and/or a voucher or coupon for a complimentary product, additional service activity and/or a discount on future service activity, to the end-user along the network 10 to the customer access portal 160, including without limitation, as an output on an software app on a mobile device 163 of the end-user that forms part of the customer access portal 160 or is coupled thereto.

Turning now to FIG. 13, there is shown an example format of a CLP entitlement datum 1300 generated by the customer loyalty administrator 580 to communicate such entitlement, for receipt, without limitation, by the customer access portal 160, including without limitation, as an output on a software app on a mobile device 163 of the end-user that forms part of the customer access portal 160 or is coupled thereto, to the TDMP 112, to the POS datum generator 115, and/or to the end-user along the network 10 to the customer access portal 160, including without limitation, as an output on an software app on a mobile device 163 of the end-user that forms part of the customer access portal 160 or is coupled thereto.

In some non-limiting examples, the CLP entitlement datum 1300 comprises a unique record number 1310, a date 1320 and/or a time 1321 that the CLP entitlement datum was recorded, a vehicle datum in the form of a vehicle record 1330 and/or at least one CLP award datum in the form of a CLP award record 1340. In some non-limiting examples, the vehicle record 1330 may be substantially the same as the vehicle record 230 set out in FIG. 3.

FIG. 14 is an example format of the CLP award record 1340 that forms part of the CLP entitlement datum 1300. In some non-limiting examples, the CLP award record 1340 comprises a unique record number 1410, a unique identifier of the vehicle, such as a VIN 1411, a date 1420 and/or a time 1421 that the CLP award record 1340 was recorded, values representing information describing the award, in the form of an award type 1460, an award description 1461, an activity code 1430, an activity description 1431, and/or notes 1480, and/or information describing an award value, in the form of a quantity 1440, a time 1441, a number of units 1442, an amount 1450, and/or a discount or premium applicable thereto 1451.

The notes 1480 field in the CLP award record 1340 may be used to house information to appear in conjunction with the information in the CLP award datum 1300, including without limitation, a summary of the CLP thresholds, a summary of an entitlement threshold that has been achieved, and/or a summary of a gap to be overcome to achieve a further entitlement threshold.

An example of a CLP report 1200 is shown in FIG. 12. In some non-limiting examples, it lists the report number, the information related to the end-user and the information related to the vehicle(s) associated with the end-user.

For each vehicle, in some non-limiting examples, the unique identifier, odometer reading and/or current DMV registration information is provided. In some non-limiting examples, the initial and final point of the specified range is set out.

Thereafter, in some non-limiting examples, each data set corresponding to the range is set out, showing the attribute extracted therefrom (in the example, a total actual vehicle service cost). In some non-limiting examples, a description of each datum comprising the data set is set out for reference.

In some non-limiting examples, a summary of the CLP thresholds is set out.

In some non-limiting examples, a summary of an entitlement threshold that has been achieved is set out. In some non-limiting examples, a summary of a gap to be overcome to achieve a further entitlement threshold is set out.

In some non-limiting examples, the existence of such validated data amassed, largely automatically, at the POS of service facilities, may allow for the administration, and award of entitlements thereunder, by the trend generator 130, including the customer loyalty administrator 580 thereof, of a CLP, whether for an individual facility or across a plurality of facilities, whether or not part of a common organization, that may be beneficial in marketing its service activities to potential end-users thereof.

Beyond such advantages for an end-user of such facility, the ability of a facility, whether on its own or across a plurality of facilities, whether or not part of a common organization, to provide such reports and/or capabilities, may be beneficial in marketing its service activities to potential end-users thereof

### Method Actions

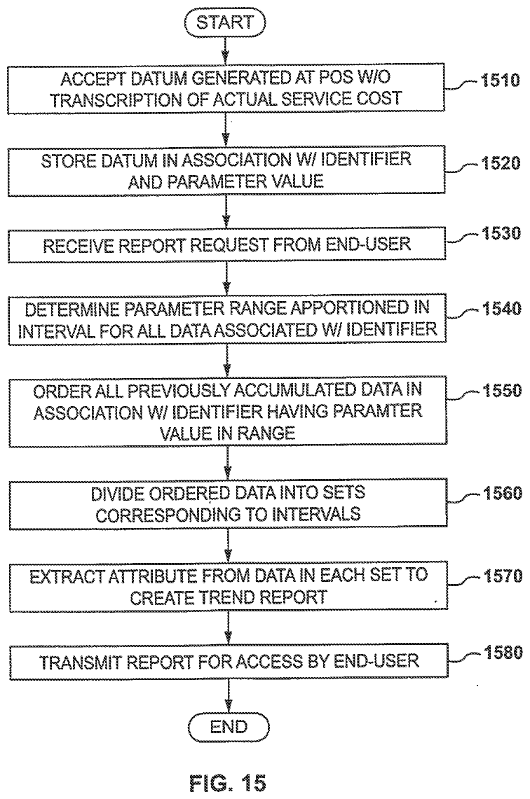

Turning to FIG. 15, there is shown a flow chart, shown generally at 1500, of example actions taken at a trend generator 130 for providing at least one trend of service costs, of a vehicle having a unique identifier, as a function of a parameter.

In some non-limiting examples, one example action 1510 is to accept at least one datum generated at a POS in a facility from a processor 115 in the facility in a manner devoid of transcription of information contained in the at least one datum comprising an actual cost of a service activity performed at the facility.

In some non-limiting examples, one example action 1520 is to store the at least one datum in association with the identifier and a value of the parameter.

In some non-limiting examples, one example action 1530 is to receive a report request from an end-user of the vehicle.

In some non-limiting examples, one example action 1540 is to determine from the request that the at least one trend is to be provided for all data associated with the identifier, for a range of the parameter, apportioned into at least one interval.

In some non-limiting examples, one example action 1550 is to order all data having a value of the parameter that lies within the range, that was previously accumulated in association with the identifier, according to the value of the parameter.

In some non-limiting examples, one example action 1560 is to divide the ordered data into sets corresponding to successive intervals within the range, based on the value of the parameter associated with each datum thereof.

In some non-limiting examples, one example action 1570 is to extract an attribute from the data in each set to create a trend report responsive to the request.

In some non-limiting examples, one example action 1580 is to transmit the report for access by the end-user.

### Technical

In some non-limiting examples, the present disclosure can be implemented advantageously on an electronic device within a computing and communications environment that may be used for implementing the devices and methods disclosed herein.

In some non-limiting examples, the electronic device typically comprises a processor and a memory. In some non-limiting examples, the electronic device may further comprise any one or more of a bus to connect components of the electronic device, a network interface, a mass storage device, a video adapter and/or an input and/or output (110) interface.

In some non-limiting examples, the electronic device may utilize all, or only a subset of such components, and levels of integration may vary from device to device.

In some non-limiting examples, the electronic device may comprise multiple instances of such components, such as, by way of non-limiting example, multiple processors, memories, transmitters and/or receivers.

In some non-limiting examples, the processor may be one or more central processing units (CPUs), including without limitation, either or both of general and specific microprocessors, and may further include specialized processors such as a graphics processing unit (GPU), digital signal processor (DSP), or other such processor, including without limitation, dedicated hardware circuits for performing a specific functionality.

In some non-limiting examples, the processor may provide functions by executing instructions, codes, computer programs and/or scripts, which it accesses from the memory and/or a mass storage device in the form of software and/or firmware and/or in any combination of hardware, software and/or firmware. In some non-limiting examples, the functions may be provided by a single dedicated processor, by a single shared processor, or by a plurality of individual processors, some of which may be shared or distributed.

In some non-limiting examples, the functions provided, including without limitation, functional blocks labelled in the drawings and described herein as “functions”, “blocks”, “modules”, “processors” and/or “controllers”, may be provided through the use of dedicated hardware, as well as hardware capable of executing software, but should not be understood to refer exclusively to such hardware.

In some non-limiting examples, such instructions, codes, computer programs and/or scripts may be implemented in a high-level procedural or object-oriented programming language, a markup language, in source, object and/or assembly code and/or machine language. In some non-limiting examples, such code or language may be compiled or interpreted. In particular, in some non-limiting examples, the foregoing description of one or more specific examples does not limit the present disclosure to any particular computer programming language, operating system, system architecture or device architecture.

In some non-limiting examples, while the instructions may be discussed in the present disclosure as being executed by a processor, in some non-limiting examples, the instructions may be executed serially, simultaneously or in parallel.

In some non-limiting examples, the memory may comprise any type of non-transitory volatile and/or non-volatile system memory, readable by the processor, such as, without limitation, random access memory (RAM), used to store volatile data and perhaps to store instructions, including without limitation, static RAM (SRAM), dynamic RAM (DRAM), synchronous DRAM (SDRAM), read-only memory (ROM), a non-volatile memory device (which typically has a small memory capacity relative to the memory capacity of mass storage devices), such as, without limitation, programmable ROM (PROM), erasable PROM (EPROM), electrically erasable PROM (EEPROM), flash memory devices, or any combination thereof. In some non-limiting examples, access to either both of RAM and/or ROM is typically faster than to mass storage devices. In some non-limiting examples, the memory may be implemented as and/or comprise one or more buffer circuits, such as, without limitation, a latch or a flip flop. In some non-limiting examples, the memory can be supplemented by, or incorporated in, any one or more of an application-specific integrated circuit (ASIC), field-programmable gate array (FPGA) and/or DSP.

In some non-limiting examples, the processor will receive instructions and/or data from RAM and/or ROM.

In some non-limiting examples, the memory may include more than one type of memory, such as, by way of non-limiting example, ROM for use at boot-up and DRAM for program and/or data storage for use while executing instructions. In some non-limiting examples, the memory may serve as a cache or interim storage medium for storing data that otherwise would be stored in and accessed from the mass storage device.

In some non-limiting examples, the memory may be accessed directly by the processor, or indirectly along a bus, a network interface and/or an I/O interface.

In some non-limiting examples, the bus may be any one or more of any type of several bus architecture, including without limitation, a processor bus, a memory bus or memory controller, a peripheral bus, a video bus, a hard drive controller, and/or an I/O controller.

In some non-limiting examples, the network interface may be a wired network interface to connect to a network, a wireless network interface, including, without limitation, a radio access network interface for connecting to other devices over a radio link. In some non-limiting examples, the network interface may take the form of a network connectivity device, such as a modulator-demodulator (modem), a modem bank, a network card, such as, without limitation, a local area network (LAN) card, such as an ethernet card or a token ring card, a wireless LAN (WLAN) card, a radio transceiver card, such as, without limitation, a code division multiple access (CDMA) or global system for mobile communications (GSM), third generation (3G), including without limitation, general packet radio service (GPRS), universal mobile telecommunications system (UMTS), enhanced data rates for GSM evolution (EDGE), CDMA2000, wideband CDMA (W-CDMA), fourth generation (4G), including without limitation, long term evolution (LTE), WiMAX, fifth generation (5G) and/or later wireless technology card, a fiber distributed data interface (FDDI) card, a wireless local area a universal serial bus (USB) interface card, and/or some other serial interface card, a wireless interface and/or card, including without limitation, WiFi, Bluetooth, near field communications (NFC) and/or another well-known network device or interface.

In some non-limiting examples, the network interface allows the electronic device to communicate with a remote entity, such as a network such as, without limitation, an Internet or one or more intranets and/or a remote entity connected to such a network, by which the processor might receive information therefrom and/or output information thereto.

In some non-limiting examples, the network interface may comprise one or more transmitter and/or receiver for wireless or otherwise transmitting and/or receiving signals respectively.

In some non-limiting examples, the network interface may be accessed directly by the processor, or indirectly along a bus and/or another network interface and/or an I/O device.

In some non-limiting examples, the mass storage device may comprise any type of non-transitory storage device, such as, without limitation, an internal or removable drive, such as, without limitation, a magnetic tape drive, a magnetic card or disk drive, a hard disk drive, an optical disk drive, including without limitation, a video disk drive, a CD-ROM disk and/or DVD-ROM disk, a magneto-optical disk drive and/or a solid state drive.

In some non-limiting examples, the mass storage device may be configured to store instructions, data and/or other information, and to make such instructions, data and/or other information accessible to the processor. In some non-limiting examples, the mass storage device may be integrated with a heterogeneous memory.

In some non-limiting examples, the mass storage device may be accessed directly by the processor, or indirectly along a bus, a network interface and/or an I/O interface.

In some non-limiting examples, the mass storage device may generally perform storage tasks compatible with higher latency but may provide lesser or no volatility. In some non-limiting examples, the mass storage device may be used as an overflow storage device if the memory is not large enough to hold all working data.

In some non-limiting examples, the video adapter and/or I/O interface provide an interface to couple the electronic device to an internal and/or external I/O device. By way of non-limiting example, an I/O device may comprise a display coupled to the video adapter and/or a printer, a video monitor, liquid crystal display (LCD), light-emitting diode (LED) display, a touch screen display, a keyboard, keypad, switch, dial mouse, trackball, trackpad, speaker, headset, headphone, voice recognizer, card reader, paper tape reader, fingerprint, iris and/or facial scanning device, and other well-known I/O devices coupled to the I/O interface.

In some non-limiting examples, the I/O device may be accessed directly by the processor, or indirectly along a bus, a network interface and/or an I/O interface.

In some non-limiting examples, the electronic device may be an element of communications network infrastructure, such as a base station (by way of non-limiting example, a NodeB, an evolved NodeB (eNodeB or eNB), a next generation NodeB (sometimes referred to as a gNodeB or gNB), a home subscriber server (HSS), a gateway (GW) such as a packet gateway (PGW) or a serving gateway (SGW) or one of various other nodes or functions within a core network (CN) or Public Land Mobility Network (PLMN).

In some non-limiting examples, the electronic device may be a device that connects to the network infrastructure over a radio interface, such as a mobile telephone, smartphone, personal digital assistant (PDA) or other handheld device, personal computer (PC), audio-visual (AV) terminal, television, video monitor and other devices that may be classified as a user equipment (UE).

In some non-limiting examples, the electronic device may be a machine type communications (MTC) device (also referred to as a machine-to-machine (M2M) device), or another such device that may be categorized as a UE despite not providing a direct service to a user.

In some non-limiting examples, the electronic device may also be referred to as a mobile device, a term intended to reflect devices that connect to a mobile network, regardless of whether the device itself is designed for, or capable of, mobility.

In some non-limiting examples, when the electronic device is a network infrastructure element, the radio access network interface may be omitted for nodes or functions acting as elements of the PLMN, other than those at the radio edge (such as, without limitation, an eNB) of a network.

In some non-limiting examples, when the electronic device is infrastructure at the radio edge of the network, both wired and/or wireless network interface may be provided.

In some non-limiting examples, when the electronic device is a wirelessly-connected device, such as, without limitation, a UE, the radio access network interface may be present and may be supplemented by other wireless interfaces, such as, without limitation, WiFi, Bluetooth and/or NFC network interfaces.

In some non-limiting examples, the electronic device may be a stand-alone device, while in other examples, the electronic device may be resident within a data center. As will be understood by those having ordinary skill in the art, a data centre is a collection of computing resources (typically in the form of services) that can be used as a collective computing and/or storage resource. In some non-limiting examples, within a data centre, a plurality of services can be connected together to provide a computing resource pool upon which virtualized entities can be instantiated. In some non-limiting examples, data centers can be coupled together to form networks consisting of pooled computing and/or storage resources coupled to one or another by connectivity resources.

In some non-limiting examples, the connectivity resources may take the form of physical connections such as ethernet and/or optical communications links, and in some instances, may include wireless communication channels as well. In some non-limiting examples, if two different data centers are coupled by a plurality of different communication channels, the links can be combined tougher using any of a number of techniques, including without limitation, the formation of link aggregation groups (LAGs).

In some non-limiting examples, it should be understood that any or all of the computing, storage and/or connectivity resources (along with other resources within the network) may be divided among different sub-networks, in some cases, in the form of a resource slice. In some non-limiting examples, if the resources across a number of coupled data or other collection of nodes are sliced, different network slices can be created.

Those having ordinary skill in the relevant art will appreciate that in some non-limiting examples, where the electronic device is part of a data center, the I/O interface(s) and/or video adapter(s) may be virtualized and provided through a network interface.

Thus, the electronic device may be, in some non-limiting examples, a programmable processing system suitable for implementing or performing one or more of the apparatus(es) or method(s) of the present disclosure. Those having ordinary skill in the relevant art will appreciate that in some non-limiting examples, it is understood that typically, the electronic device will have sufficient processing power, memory and/or mass storage resources and/or network throughput capability to adequately handle the workload imposed upon it by such apparatus(es) and/or method(s).

The apparatus(es) of the present disclosure may in some non-limiting examples be implemented in a computer program product tangibly embodied in a machine-readable storage device, including without limitation, the memory and/or mass storage device, for execution by the processor and the method(s) and/or action(s) of the present disclosure can be performed by the processor executing one or more instructions, whether or not in a program thereof, to perform functions of the disclosure, by operating on input data and/or generating output data.

In some non-limiting examples, information comprising the instructions and/or data to be acted upon by the processor, may be received and/or outputted by the processor in the form of a computer data baseband signal and/or a signal embodied in a carrier wave. In some non-limiting examples, the information may be exchanged between the electronic device and a network.

In some non-limiting examples, the signal may propagate in or on the surface of an electrical conductor, in a coaxial cable, in a waveguide, in an optical medium, including without limitation, an optical fiber, or in the air or free space. In some non-limiting examples, the information contained in the signal may be ordered according to different sequences, as may be desirable for either processing and/or generating the information, and/or in transmitting and/or receiving the information. In some non-limiting examples, the signal, whether baseband or embedded in a carrier wave, or other types of signals currently used or hereafter developed, and referred to herein as the transmission medium, may be generated according to several well-known methods.

Thus, in some non-limiting examples, an article of manufacture for use with an apparatus of the present disclosure, such as a pre-recorded storage device or other computer-readable medium, including program instructions recorded thereon, or a computer data signal carrying computer-readable program instructions may direct an apparatus of the present disclosure to facilitate the practice of a method of the present disclosure. It is understood that such apparatus(es), articles of manufacture and/or computer data signals also come within the scope of the present disclosure.

### Terminology

References in the singular form include the plural and vice versa, unless otherwise noted.

As used herein, relational terms, such as “first” and “second”, and numbering devices such as “a”, “b” and the like, may be used solely to distinguish one entity or element from another entity or element, without necessarily requiring or implying any physical or logical relationship or order between such entities or elements.

The terms “including” and “comprising” are used in an open-ended fashion, and thus should be interpreted to mean “including, but not limited to”. The terms “example” and “exemplary” are used simply to identify instances for illustrative purposes and should not be interpreted as limiting the scope of the invention to the stated instances. In particular, the term “exemplary” should not be interpreted to denote or confer any laudatory, beneficial or other quality to the expression with which it is used, whether in terms of design, performance or otherwise.

The terms “couple” and “communicate” in any form are intended to mean either a direct connection or indirect connection through some interface, device, intermediate component or connection, whether optically, electrically, mechanically, chemically, or otherwise.

Directional terms such as “upward”, “downward”, “left” and “right” are used to refer to directions in the drawings to which reference is made unless otherwise stated. Similarly, words such as “inward” and “outward” are used to refer to directions toward and away from, respectively, the geometric center of the device, area or volume or designated parts thereof. Moreover, all dimensions described herein are intended solely to be by way of example of purposes of illustrating certain embodiments and are not intended to limit the scope of the disclosure to any embodiments that may depart from such dimensions as may be specified.

### General

The purpose of the Abstract is to enable the relevant patent office or the public generally, and specifically, persons of ordinary skill in the art who are not familiar with patent or legal terms or phraseology, to quickly determine from a cursory inspection, the nature of the technical disclosure. The Abstract is neither intended to define the scope of this disclosure, nor is it intended to be limiting as to the scope of this disclosure in any way.

The structure, manufacture and use of the presently disclosed examples have been discussed above. The specific examples discussed are merely illustrative of specific ways to make and use the concepts disclosed herein, and do not limit the scope of the present disclosure. Rather, the general principles set forth herein are considered to be merely illustrative of the scope of the present disclosure.

It should be appreciated that the present disclosure, which is described by the claims and not by the implementation details provided, and which can be modified by varying, omitting, adding or replacing elements with alternatives and/or equivalent functional elements, will be apparent to those having ordinary skill in the relevant art, may be made to the examples disclosed herein, and may provide many applicable inventive concepts that may be embodied in a wide variety of specific contexts, without straying from the present disclosure.

In particular, features, techniques, systems, sub-systems and methods described and illustrated in one or more of the above-described examples, whether or not described an illustrated as discrete or separate, may be combined or integrated in another system without departing from the scope of the present disclosure, to create alternative examples comprised of a combination or sub-combination of features that may not be explicitly described above, or certain features may be omitted, or not implemented. Features suitable for such combinations and sub-combinations would be readily apparent to persons skilled in the art upon review of the present application as a whole. Other examples of changes, substitutions, and alterations are easily ascertainable and could be made without departing from the spirit and scope disclosed herein.

All statements herein reciting principles, aspects and examples of the disclosure, as well as specific examples thereof, are intended to encompass both structural and functional equivalents thereof and to cover and embrace all suitable changes in technology. Additionally, it is intended that such equivalents include both currently-known equivalents as well as equivalents developed in the future, i.e., any elements developed that perform the same function, regardless of structure.

Accordingly, the specification and the examples disclosed therein are to be considered illustrative only, with a true scope of the disclosure being disclosed by the following numbered claims.

### Clauses

Non-limiting examples are described in the following clauses:

A trend generator for providing at least one trend of service costs, of a vehicle having a unique identifier, as a function of a parameter, comprising:

a receiver for accepting, at least one of: a report request from an end-user of the vehicle and at least one datum generated at a point of sale in a service facility, from a processor in the facility in a manner devoid of transcription of information contained therein, the at least one datum comprising an actual cost of a service activity performed at the facility;

a sorter for forwarding the request and for storing the at least one datum in association with the identifier and a value of the parameter;

a trend engine for:

determining from the request that the at least one trend is to be provided for all data associated with the identifier, for a range of the parameter, apportioned into at least one interval;

ordering data having a value of the parameter that lies within the range, that was previously accumulated in association with the identifier, according to the value of the parameter;

dividing the ordered data into sets corresponding to successive intervals within the range, based on the value of the parameter associated with each datum thereof; and

extracting an attribute from the data in each set to create a trend report responsive to the request; and

a transmitter for providing the report for access by the end-user.

The trend generator according to any one or more of the preceding and/or following clauses, wherein the parameter is at least one of: date, time and accumulated mileage.

The trend generator according to any one or more of the preceding and/or following clauses, wherein the receiver is adapted to accept at least one transcribed datum comprising a transcription of an actual cost of a service activity performed at at least one of: the facility and another facility, and the sorter is adapted to store the at least one transcribed datum.

The trend generator according to any one or more of the preceding and/or following clauses, wherein the trend generator is adapted to confirm that security measures have been taken to preclude provision of false information in the at least one transcribed datum.

The trend generator according to any one or more of the preceding and/or following clauses, wherein the security measures are provided by the receiver when receiving the at least one transcribed datum.

The trend generator according to any one or more of the preceding and/or following clauses wherein the security measures are provided when the transcription is performed.

The trend generator according to any one or more of the preceding and/or following clauses, wherein the receiver receives the request from at least one of: a processor in the facility, a processor of the end-user, the end-user, another trend generator, and a government vehicle registry.

The trend generator according to any one or more of the preceding and/or following clauses, wherein the receiver is adapted to accept the at least one datum from a government vehicle registry.

The trend generator according to any one or more of the preceding and/or following clauses, further comprising a data repository for maintaining the at least one datum stored by the sorter and permitting access thereto by the trend engine.

The trend generator according to any one or more of the preceding and/or following clauses, wherein the transmitter provides the report to the end-user at at least one of: a processor in the facility a processor of the end-user, the end-user and a government vehicle registry.

The trend generator according to any one of claims 1 to 10, wherein the at least one datum comprises a vehicle datum comprising the identifier and at least one service activity datum.

The trend generator according to any one or more of the preceding and/or following clauses, wherein the vehicle datum comprises at least one of: a vehicle identification number (VIN) of the vehicle, a date, a time, a mileage, a government registration identifier, information describing the vehicle, and information describing the end-user.

The trend generator according to any one or more of the preceding and/or following clauses, wherein the at least one service activity datum comprises at least one of: a vehicle identification number (VIN) of the vehicle, a date, a time, a mileage, information describing the service activity and information describing a service cost of performing the service activity.

The trend generator according to any one or more of the preceding and/or following clauses, wherein the range begins at a value of the parameter at an initial event that is at least one of: when the end-user obtained the vehicle, when a previous end-user of the vehicle obtained the vehicle, a beginning of a calendar year, a beginning of a fiscal year of the end-user, an initial service activity performed on the vehicle, a mileage threshold of the vehicle and a significant event of the end-user.

The trend generator according to any one or more of the preceding and/or following clauses, wherein the parameter is a date and the interval is at least one of: a range of consecutive years, a year, a half-year, a quarter, a trimester and a month.

The trend generator according to any one or more of the preceding and/or following clauses, wherein the parameter is an accumulated mileage and the interval is at least one of: 100,000 miles, 50,000 miles, 20,000 miles, 10,000 miles, 5,000 miles, 2,000 miles, 1,000 miles, 500 miles, 250 miles, 100 miles, 50 miles, 200,000 km, 100,000 km, 50,000 km, 20,000 km, 10,000 km, 5,000 km, 2,000 km, 1,000 km, 500 km, 250 km and 100 km.

The trend generator according to any one or more of the preceding and/or following clauses, wherein the attribute extracted is at least one of: a total service cost, an average service cost, a median service cost, a number of service appointments, a number of service activities, a category of service activities, a type of service activity, a total duration of service activities, an average duration of service activities, a median duration of service activities, a number of days in a service facility, a duration of a service activities and a number of unit hours incurred in a service activity of the data in the set.

The trend generator according to any one or more of the preceding and/or following clauses, wherein the service facility is at least one of: an automotive repair facility, a fuel refilling station, a car dealership, a service department of a dealership, a parts department of a dealership, a government vehicle registry and another end-user.

The trend generator according to any one or more of the preceding and/or following clauses, further comprising a comparator for receiving a comparison report request, juxtaposing at least one of the trend and the ordered data against an estimate of vehicle service costs for at least one interval within the range to create a comparison report responsive thereto.

The trend generator according to any one or more of the preceding and/or following clauses, further comprising a historian for receiving a history report request and listing at least a subset of all data associated with the vehicle to create a history report responsive thereto.

The trend generator according to any one or more of the preceding and/or following clauses, further comprising a calculator for receiving a use category report request and allocating the data associated with the vehicle within the range to one of a plurality of use categories, based at least one use datum, each identifying a subset of the range and allocated to one of the categories to create a use category report responsive thereto.

The trend generator according to any one or more of the preceding and/or following clauses, wherein the receiver accepts the use data from at least one of: a processor of the end-user and the end-user.

The trend generator according to any one or more of the preceding and/or following clauses, further comprising a customer loyalty administrator for accumulating the data associated with at least one vehicle of the end-user in the range and awarding at least one entitlement under a customer loyalty program (CLP) conditioned on at least one of: the vehicle and the end-user, when at least one threshold of the CLP is exceeded by a feature of the accumulated data.

The trend generator according to any one or more of the preceding and/or following clauses, wherein the feature is at least one of: the total service cost, a number of service activities and a type of service activity of the accumulated data in the range.

A system for providing at least one trend of service costs, of a vehicle having a unique identifier, as a function of a parameter, comprising:

a service facility having a processor, for performing a service activity on the vehicle and communicating at least one datum comprising an actual cost of the service activity, generated by the processor at a point of sale in the facility, in a manner devoid of transcription of information contained therein;

a trend generator comprising:
a receiver for accepting, at least one of: a report request from an end-user of the vehicle and the at least one datum;
a sorter for forwarding the request and for storing the at least one datum in association with the identifier and a value of the parameter;
a trend engine for:
   determining from the request that the at least one trend is to be provided for all data associated with the identifier, for a range of the parameter, apportioned into at least one interval;
   ordering data having a value of the parameter that lies within the range, that was previously accumulated in association with the identifier, according to the value of the parameter;
   dividing the ordered data into sets corresponding to successive intervals within the range, based on the value of the parameter associated with each datum thereof; and
   exacting an attribute from the data in each set to create a trend report responsive to the request; and
a transmitter for providing the report for access by the end-user.

The system according to any one or more of the preceding and/or following clauses, wherein the parameter is at least one of: date, time and accumulated mileage.

The system according to any one or more of the preceding and/or following clauses, wherein the receiver is adapted to accept at least one transcribed datum comprising a transcription of an actual cost of a service activity performed at at least one of: the facility and another facility, and the sorter is adapted to store the at least one transcribed datum.

The system according to any one or more of the preceding and/or following clauses, wherein the trend generator is adapted to confirm that security measures have been taken to preclude provision of false information in the at least one transcribed datum.

The system according to any one or more of the preceding and/or following clauses, wherein the security measures are provided by the receiver when receiving the at least one transcribed datum.

The system according to any one or more of the preceding and/or following clauses wherein the security measures are provided when the transcription is performed.

The system according to any one or more of the preceding and/or following clauses, wherein the receiver receives the request from at least one of: a processor in the facility, a processor of the end-user, the end-user, another trend generator, and a government vehicle registry.

The system according to any one or more of the preceding and/or following clauses, wherein the receiver is adapted to accept the at least one datum from a government vehicle registry.

The system according to any one or more of the preceding and/or following clauses, further comprising a data repository for maintaining the at least one datum stored by the sorter and permitting access thereto by the trend engine.

The system according to any one or more of the preceding and/or following clauses, wherein the transmitter provides the report to the end-user at at least one of: a processor in the facility a processor of the end-user, the end-user and a government vehicle registry.

The system according to any one or more of the preceding and/or following clauses, wherein the at least one datum comprises a vehicle datum comprising the identifier and at least one service activity datum.

The system according to any one or more of the preceding and/or following clauses, wherein the vehicle datum comprises at least one of: a vehicle identification number (VIN) of the vehicle, a date, a time, a mileage, a government registration identifier, information describing the vehicle, and information describing the end-user.

The system according to any one or more of the preceding and/or following clauses, wherein the at least one service activity datum comprises at least one of: a vehicle identification number (VIN) of the vehicle, a date, a time, a mileage, information describing the service activity and information describing a service cost of performing the service activity.

The system according to any one or more of the preceding and/or following clauses, wherein the range begins at a value of the parameter at an initial event that is at least one of: when the end-user obtained the vehicle, when a previous end-user of the vehicle obtained the vehicle, a beginning of a calendar year, a beginning of a fiscal year of the end-user, an initial service activity performed on the vehicle, a mileage threshold of the vehicle and a significant event of the end-user.

The system according to any one or more of the preceding and/or following clauses, wherein the parameter is a date and the interval is at least one of: a range of consecutive years, a year, a half-year, a quarter, a trimester and a month.

The system according to any one or more of the preceding and/or following clauses, wherein the parameter is an accumulated mileage and the interval is at least one of: 100,000 miles, 50,000 miles, 20,000 miles, 10,000 miles, 5,000 miles, 2,000 miles, 1,000 miles, 500 miles, 250 miles, 100 miles, 50 miles, 200,000 km, 100,000 km, 50,000 km, 20,000 km, 10,000 km, 5,000 km, 2,000 km, 1,000 km, 500 km, 250 km and 100 km.

The system according to any one or more of the preceding and/or following clauses, wherein the attribute extracted is at least one of: a total service cost, an average service cost, a median service cost, a number of service appointments, a number of service activities, a category of service activities, a type of service activity, a total duration of service activities, an average duration of service activities, a median duration of service activities, a number of days in a service facility, a duration of a service activities and a number of unit hours incurred in a service activity of the data in the set.

The system according to any one or more of the preceding and/or following clauses, wherein the service facility is at least one of: an automotive repair facility, a fuel refilling station, a car dealership, a service department of a dealership, a parts department of a dealership, a government vehicle registry and another end-user.

The system according to any one or more of the preceding and/or following clauses, further comprising a comparator for receiving a comparison report request, juxtaposing at least one of the trend and the ordered data against an estimate of vehicle service costs for at least one interval within the range to create a comparison report responsive thereto.

The system according to any one or more of the preceding and/or following clauses, further comprising a historian for receiving a history report request and listing at least a subset of all data associated with the vehicle to create a history report responsive thereto.

The system according to any one or more of the preceding and/or following clauses, further comprising a calculator for receiving a use category report request and allocating the data associated with the vehicle within the range to one of a plurality of use categories, based at least one use datum, each identifying a subset of the range and allocated to one of the categories to create a use category report responsive thereto.

The system according to any one or more of the preceding and/or following clauses, wherein the receiver accepts the use data from at least one of: a processor of the end-user and the end-user.

The system according to any one or more of the preceding and/or following clauses, further comprising a customer loyalty administrator for accumulating the data associated with at least one vehicle of the end-user in the range and awarding at least one entitlement under a customer loyalty program (CLP) conditioned on at least one of: the vehicle and the end-user, when at least one threshold of the CLP is exceeded by a feature of the accumulated data.

The system according to any one or more of the preceding and/or following clauses, wherein the feature is at least one of: the total service cost, a number of service activities and a type of service activity of the accumulated data in the range.

A method for providing at least one trend of service costs, of a vehicle having a unique identifier, as a function of a parameter, comprising actions of:

accepting at least one datum generated at a point of sale in a service facility, from a processor in the facility in a manner devoid of transcription of information contained therein, the at least one datum comprising an actual cost of a service activity performed at the facility;

storing the at least one datum in association with the identifier and a value of the parameter;

receiving a report request from an end-user of the vehicle;

determining from the request that the at least one trend is to be provided for all data associated with the identifier, for a range of the parameter, apportioned into at least one interval;

ordering data having a value of the parameter that lies within the range, that was previously accumulated in association with the identifier, according to the value of the parameter;

dividing the ordered data into sets corresponding to successive intervals within the range, based on the value of the parameter associated with each datum thereof; and

extracting an attribute from the data in each set to create a trend report responsive to the request; and

transmitting the report for access by the end-user.

The method according to any one or more of the preceding and/or following clauses, wherein the parameter is at least one of: date, time and accumulated mileage.

The method according to any one or more of the preceding and/or following clauses, further comprising actions of: accepting at least one transcribed datum comprising a transcription of an actual cost of a service activity performed at at least one of: the facility and another facility and storing the at least one transcribed datum.

The method according to any one or more of the preceding and/or following clauses, wherein the instructions further cause the trend generator to provide the trend by taking security measures to preclude provision of false information in the at least one transcribed datum.

The method according to any one or more of the preceding and/or following clauses, wherein the security measures are provided when receiving the at least one transcribed datum.

The method according to any one or more of the preceding and/or following clauses wherein the security measures are provided when the transcription is performed.

The method according to any one or more of the preceding and/or following clauses, wherein the method is performed by a trend generator and the request is received from at least one of: a processor in the facility, a processor of the end-user, the end-user, another trend generator, and a government vehicle registry.

The method according to any one or more of the preceding and/or following clauses, wherein the at least one datum is accepted from a government vehicle registry.

The method according to any one or more of the preceding and/or following clauses, wherein the report is provided to the end-user at at least one of: a processor in the facility a processor of the end-user, the end-user and a government vehicle registry.

The method according to any one or more of the preceding and/or following clauses, wherein the at least one datum comprises a vehicle datum comprising the identifier and at least one service activity datum.

The method according to any one or more of the preceding and/or following clauses, wherein the vehicle datum comprises at least one of: a vehicle identification number (VIN) of the vehicle, a date, a time, a mileage, a government registration identifier, information describing the vehicle, and information describing the end-user.

The method according to any one or more of the preceding and/or following clauses, wherein the at least one service activity datum comprises at least one of: a vehicle identification number (VIN) of the vehicle, a date, a time, a mileage, information describing the service activity and information describing a service cost of performing the service activity.

The method according to any one or more of the preceding and/or following clauses, wherein the range begins at a value of the parameter at an initial event that is at least one of: when the end-user obtained the vehicle, when a previous end-user of the vehicle obtained the vehicle, a beginning of a calendar year, a beginning of a fiscal year of the end-user, an initial service activity performed on the vehicle, a mileage threshold of the vehicle and a significant event of the end-user.

The method according to any one or more of the preceding and/or following clauses, wherein the parameter is a date and the interval is at least one of: a range of consecutive years, a year, a half-year, a quarter, a trimester and a month.

The method according to any one or more of the preceding and/or following clauses, wherein the parameter is an accumulated mileage and the interval is at least one of: 100,000 miles, 50,000 miles, 20,000 miles, 10,000 miles, 5,000 miles, 2,000 miles, 1,000 miles, 500 miles, 250 miles, 100 miles, 50 miles, 200,000 km, 100,000 km, 50,000 km, 20,000 km, 10,000 km, 5,000 km, 2,000 km, 1,000 km, 500 km, 250 km and 100 km.

The method according to any one or more of the preceding and/or following clauses, wherein the attribute extracted is at least one of: a total service cost, an average service cost, a median service cost, a number of service appointments, a number of service activities, a category of service activities, a type of service activity, a total duration of service activities, an average duration of service activities, a median duration of service activities, a number of days in a service facility, a duration of a service activities and a number of unit hours incurred in a service activity of the data in the set.

The method according to any one or more of the preceding and/or following clauses, wherein the service facility is at least one of: an automotive repair facility, a fuel refilling station, a car dealership, a service department of a dealership, a parts department of a dealership, a government vehicle registry and another end-user.

The method according to any one or more of the preceding and/or following clauses, wherein the action of receiving comprises actions of: receiving a comparison report request, juxtaposing at least one of the trend and the ordered data against an estimate of vehicle service costs for at least one interval within the range and creating a comparison report responsive thereto.

The method according to any one or more of the preceding and/or following clauses, wherein the action of receiving comprises actions of: receiving a history report request, listing at least a subset of all data associated with the vehicle and creating a history report responsive thereto.

The method according to any one or more of the preceding and/or following clauses, wherein the action of receiving comprises actions of: obtaining at least one use datum, each identifying a subset of the range, receiving a use category report request and allocating the data associated with the vehicle within the range to one of a plurality of use categories, based on the use data, allocating each at least one use datum to one of the categories and creating a use category report responsive thereto.

The method according to any one or more of the preceding and/or following clauses, wherein the use data is obtained from at least one of: a processor of the end-user and the end-user.

The method according to any one or more of the preceding and/or following clauses, wherein the action of receiving comprises: accumulating the data associated with at least one vehicle of the end-user in the range and awarding at least one entitlement under a customer loyalty program (CLP) conditioned on at least one of: the vehicle and the end-user, when at least one threshold of the CLP is exceeded by a feature of the accumulated data.

The method according to any one or more of the preceding and/or following clauses, wherein the feature is at least one of: the total service cost, a number of service activities and a type of service activity of the accumulated data in the range.

A trend generator comprising:

a processor;

a non-transitory memory for storing instructions that, when executed by the processor, cause the trend generator to provide at least one trend of service costs, of a vehicle having a unique identifier, as a function of a parameter, by:
accepting at least one datum generated at a point of sale in a service facility, from a processor in the facility in a manner devoid of transcription of information contained therein, the at least one datum comprising an actual cost of a service activity performed at the facility;
storing the at least one datum in association with the identifier and a value of the parameter;
receiving a report request from an end-user of the vehicle;
determining from the request that the at least one trend is to be provided for all data associated with the identifier, for a range of the parameter, apportioned into at least one interval;
ordering data having a value of the parameter that lies within the range, that was previously accumulated in association with the identifier, according to the value of the parameter;
dividing the ordered data into sets corresponding to successive intervals within the range, based on the value of the parameter associated with each datum thereof; and
extracting an attribute from the data in each set to create a trend report responsive to the request; and
transmitting the report for access by the end-user.

The trend generator according to any one or more of the preceding and/or following clauses, wherein the parameter is at least one of: date, time and accumulated mileage.

The trend generator according to any one or more of the preceding and/or following clauses, wherein the instructions further cause the trend generator to provide the trend by: accepting at least one transcribed datum comprising a transcription of an actual cost of a service activity performed at at least one of: the facility and another facility, and storing the at least one transcribed datum.

The trend generator according to any one or more of the preceding and/or following clauses, wherein the instructions further cause the trend generator to provide the trend by taking security measures to preclude provision of false information in the at least one transcribed datum.

The trend generator according to any one or more of the preceding and/or following clauses, wherein the security measures are provided when receiving the at least one transcribed datum.

The trend generator according to any one or more of the preceding and/or following clauses wherein the security measures are provided when the transcription is performed.

The trend generator according to any one or more of the preceding and/or following clauses, wherein the request is received from at least one of: a processor in the facility, a processor of the end-user, the end-user, another trend generator, and a government vehicle registry.

The trend generator according to any one or more of the preceding and/or following clauses, wherein the at least one datum is accepted from a government vehicle registry.

The trend generator according to any one or more of the preceding and/or following clauses, wherein the report is provided to the end-user at at least one of: a processor in the facility a processor of the end-user, the end-user and a government vehicle registry.

The trend generator according to any one or more of the preceding and/or following clauses, wherein the at least one datum comprises a vehicle datum comprising the identifier and at least one service activity datum.

The trend generator according to any one or more of the preceding and/or following clauses, wherein the vehicle datum comprises at least one of: a vehicle identification number (VIN) of the vehicle, a date, a time, a mileage, a government registration identifier, information describing the vehicle, and information describing the end-user.

The trend generator according to any one or more of the preceding and/or following clauses, wherein the at least one service activity datum comprises at least one of: a vehicle identification number (YIN) of the vehicle, a date, a time, a mileage, information describing the service activity and information describing a service cost of performing the service activity.

The trend generator according to any one or more of the preceding and/or following clauses, wherein the range begins at a value of the parameter at an initial event that is at least one of: when the end-user obtained the vehicle, when a previous end-user of the vehicle obtained the vehicle, a beginning of a calendar year, a beginning of a fiscal year of the end-user, an initial service activity performed on the vehicle, a mileage threshold of the vehicle and a significant event of the end-user.

The trend generator according to any one or more of the preceding and/or following clauses, wherein the parameter is a date and the interval is at least one of: a range of consecutive years, a year, a half-year, a quarter, a trimester and a month.

The trend generator according to any one or more of the preceding and/or following clauses, wherein the parameter is an accumulated mileage and the interval is at least one of: 100,000 miles, 50,000 miles, 20,000 miles, 10,000 miles, 5,000 miles, 2,000 miles, 1,000 miles, 500 miles, 250 miles, 100 miles, 50 miles, 200,000 km, 100,000 km, 50,000 km, 20,000 km, 10,000 km, 5,000 km, 2,000 km, 1,000 km, 500 km, 250 km and 100 km.

The trend generator according to any one or more of the preceding and/or following clauses, wherein the attribute extracted is at least one of: a total service cost, an average service cost, a median service cost, a number of service appointments, a number of service activities, a category of service activities, a type of service activity, a total duration of service activities, an average duration of service activities, a median duration of service activities, a number of days in a service facility, a duration of a service activities and a number of unit hours incurred in a service activity of the data in the set.

The trend generator according to any one or more of the preceding and/or following clauses, wherein the service facility is at least one of: an automotive repair facility, a fuel refilling station, a car dealership, a service department of a dealership, a parts department of a dealership, a government vehicle registry and another end-user.

The trend generator according to any one or more of the preceding and/or following clauses, wherein the action of receiving comprises actions of: receiving a comparison report request, juxtaposing at least one of the trend and the ordered data against an estimate of vehicle service costs for at least one interval within the range and creating a comparison report responsive thereto.

The trend generator according to any one or more of the preceding and/or following clauses, wherein the action of receiving comprises actions of: receiving a history report request, listing at least a subset of all data associated with the vehicle and creating a history report responsive thereto.

The trend generator according to any one or more of the preceding and/or following clauses, wherein the action of receiving comprises actions of: obtaining at least one use datum, each identifying a subset of the range, receiving a use category report request and allocating the data associated with the vehicle within the range to one of a plurality of use categories, based on the use data, allocating each at least one use datum to one of the categories and creating a use category report responsive thereto.

The trend generator according to any one or more of the preceding and/or following clauses, wherein the use data is obtained from at least one of: a processor of the end-user and the end-user.

The trend generator according to any one or more of the preceding and/or following clauses, wherein the action of receiving comprises: accumulating the data associated with at least one vehicle of the end-user in the range and awarding at least one entitlement under a customer loyalty program (CLP) conditioned on at least one of: the vehicle and the end-user, when at least one threshold of the CLP is exceeded by a feature of the accumulated data.

The trend generator according to any one or more of the preceding and/or following clauses, wherein the feature is at least one of: the total service cost, a number of service activities and a type of service activity of the accumulated data in the range.

A computer-readable medium operatively coupled to a processor operatively coupled to a trend generator for providing at least one trend of service costs, of a vehicle having a unique identifier, as a function of a parameter, the medium having stored thereon, computer-readable and computer-executable instructions which, when executed by the processor, cause the processor to perform actions of:

accepting at least one datum generated at a point of sale in a service facility, from a processor in the facility in a manner devoid of transcription of information contained therein, the at least one datum comprising an actual cost of a service activity performed at the facility;

storing the at least one datum in association with the identifier and a value of the parameter;

receiving a report request from an end-user of the vehicle;

determining from the request that the at least one trend is to be provided for all data associated with the identifier, for a range of the parameter, apportioned into at least one interval;

ordering data having a value of the parameter that lies within the range, that was previously accumulated in association with the identifier, according to the value of the parameter;

dividing the ordered data into sets corresponding to successive intervals within the range, based on the value of the parameter associated with each datum thereof; and

extracting an attribute from the data in each set to create a trend report responsive to the request; and

transmitting the report for access by the end-user.

The computer-readable medium according to any one or more of the preceding and/or following clauses, wherein the parameter is at least one of: date, time and accumulated mileage.

The computer-readable medium according to any one or more of the preceding and/or following clauses, wherein the instructions further cause the processor to perform actions of: accepting at least one transcribed datum comprising a transcription of an actual cost of a service activity performed at at least one of: the facility and another facility, and storing the at least one transcribed datum.

The computer-readable medium according to any one or more of the preceding and/or following clauses, wherein the instructions further cause the processor to perform actions of taking security measures to preclude provision of false information in the at least one transcribed datum.

The computer-readable medium according to any one or more of the preceding and/or following clauses, wherein the security measures are provided when receiving the at least one transcribed datum.

The computer-readable medium according to any one or more of the preceding and/or following clauses wherein the security measures are provided when the transcription is performed.

The computer-readable medium according to any one or more of the preceding and/or following clauses, wherein the request is received from at least one of: a processor in the facility, a processor of the end-user, the end-user, another trend generator, and a government vehicle registry.

The computer-readable medium according to any one or more of the preceding and/or following clauses, wherein the at least one datum is accepted from a government vehicle registry.

The computer-readable medium according to any one or more of the preceding and/or following clauses, wherein the report is provided to the end-user at at least one of: a processor in the facility a processor of the end-user, the end-user and a government vehicle registry.

The computer-readable medium according to any one or more of the preceding and/or following clauses, wherein the at least one datum comprises a vehicle datum comprising the identifier and at least one service activity datum.

The computer-readable medium according to any one or more of the preceding and/or following clauses, wherein the vehicle datum comprises at least one of: a vehicle identification number (VIN) of the vehicle, a date, a time, a mileage, a government registration identifier, information describing the vehicle, and information describing the end-user.

The computer-readable medium according to any one or more of the preceding and/or following clauses, wherein the at least one service activity datum comprises at least one of: a vehicle identification number (VIN) of the vehicle, a date, a time, a mileage, information describing the service activity and information describing a service cost of performing the service activity.

The computer-readable medium according to any one or more of the preceding and/or following clauses, wherein the range begins at a value of the parameter at an initial event that is at least one of: when the end-user obtained the vehicle, when a previous end-user of the vehicle obtained the vehicle, a beginning of a calendar year, a beginning of a fiscal year of the end-user, an initial service activity performed on the vehicle, a mileage threshold of the vehicle and a significant event of the end-user.

The computer-readable medium according to any one or more of the preceding and/or following clauses, wherein the parameter is a date and the interval is at least one of: a range of consecutive years, a year, a half-year, a quarter, a trimester and a month.

The computer-readable medium according to any one or more of the preceding and/or following clauses, wherein the parameter is an accumulated mileage and the interval is at least one of: 100,000 miles, 50,000 miles, 20,000 miles, 10,000 miles, 5,000 miles, 2,000 miles, 1,000 miles, 500 miles, 250 miles, 100 miles, 50 miles, 200,000 km, 100,000 km, 50,000 km, 20,000 km, 10,000 km, 5,000 km, 2,000 km, 1,000 km, 500 km, 250 km and 100 km.

The computer-readable medium according to any one or more of the preceding and/or following clauses, wherein the attribute extracted is at least one of: a total service cost, an average service cost, a median service cost, a number of service appointments, a number of service activities, a category of service activities, a type of service activity, a total duration of service activities, an average duration of service activities, a median duration of service activities, a number of days in a service facility, a duration of a service activities and a number of unit hours incurred in a service activity of the data in the set.

The computer-readable medium according to any one or more of the preceding and/or following clauses, wherein the service facility is at least one of: an automotive repair facility, a fuel refilling station, a car dealership, a service department of a dealership, a parts department of a dealership, a government vehicle registry and another end-user.

The computer-readable medium according to any one or more of the preceding and/or following clauses, wherein the action of receiving comprises actions of: receiving a comparison report request, juxtaposing at least one of the trend and the ordered data against an estimate of vehicle service costs for at least one interval within the range and creating a comparison report responsive thereto.

The computer-readable medium according to any one or more of the preceding and/or following clauses, wherein the action of receiving comprises actions of: receiving a history report request, listing at least a subset of all data associated with the vehicle and creating a history report responsive thereto.

The computer-readable medium according to any one or more of the preceding and/or following clauses, wherein the action of receiving comprises actions of: obtaining at least one use datum, each identifying a subset of the range, receiving a use category report request and allocating the data associated with the vehicle within the range to one of a plurality of use categories, based on the use data, allocating each at least one use datum to one of the categories and creating a use category report responsive thereto.

The computer-readable medium according to any one or more of the preceding and/or following clauses, wherein the use data is obtained from at least one of: a processor of the end-user and the end-user.

The computer-readable medium according to any one or more of the preceding and/or following clauses, wherein the action of receiving comprises: accumulating the data associated with at least one vehicle of the end-user in the range and awarding at least one entitlement under a customer loyalty program (CLP) conditioned on at least one of: the vehicle and the end-user, when at least one threshold of the CLP is exceeded by a feature of the accumulated data.

The computer-readable medium according to any one or more of the preceding and/or following clauses, wherein the feature is at least one of: the total service cost, a number of service activities and a type of service activity of the accumulated data in the range.

1.-117. (canceled)

118. A trend generator for providing at least one trend of service costs of a vehicle having a unique identifier, as a function of a parameter, the trend generator comprising:
a receiver for accepting, at least one of: a report request from an end-user of the vehicle and at least one datum generated at a point of sale in a service facility, from a processor in the facility in a manner devoid of transcription of information contained therein, the at least one datum comprising an actual cost of a service activity performed at the facility;
a sorter for forwarding the request and for storing the at least one datum in association with the identifier and a value of the parameter;
a trend engine for:
determining from the request that the at least one trend is to be provided for all data associated with the identifier, for a range of the parameter, apportioned into at least one interval;
ordering data having a value of the parameter that lies within the range, that was previously accumulated in association with the identifier, according to the value of the parameter;
dividing the ordered data into sets corresponding to successive intervals within the range, based on the value of the parameter associated with each datum thereof; and
extracting an attribute from the data in each set to create a trend report responsive to the request; and
a transmitter for providing the report for access by the end-user.

119. A system for providing at least one trend of service costs of a vehicle having a unique identifier, as a function of a parameter, the system comprising:
a service facility having a processor, for performing a service activity on the vehicle and communicating at least one datum comprising an actual cost of the service activity, generated by the processor at a point of sale in the facility, in a manner devoid of transcription of information contained therein;
a trend generator comprising:
a receiver for accepting, at least one of: a report request from an end-user of the vehicle and the at least one datum;
a sorter for forwarding the request and for storing the at least one datum in association with the identifier and a value of the parameter;
a trend engine for:
determining from the request that the at least one trend is to be provided for all data associated with the identifier, for a range of the parameter, apportioned into at least one interval;
ordering data having a value of the parameter that lies within the range, that was previously accumulated in association with the identifier, according to the value of the parameter;
dividing the ordered data into sets corresponding to successive intervals within the range, based on the value of the parameter associated with each datum thereof; and
extracting an attribute from the data in each set to create a trend report responsive to the request; and
a transmitter for providing the report for access by the end-user.

120. The system according to claim 119, wherein the parameter is at least one of: date, time and accumulated mileage.

121. The system according to claim 120, wherein the receiver is adapted to accept at least one transcribed datum comprising a transcription of an actual cost of a service activity performed at at least one of: the facility and another facility, and the sorter is adapted to store the at least one transcribed datum.

122. The system according to claim 121, wherein the trend generator is adapted to confirm that security measures have been taken to preclude provision of false information in the at least one transcribed datum.

123. The system according to claim 122, wherein the security measures are provided by the receiver when receiving the at least one transcribed datum.

124. The system according to claim 123, wherein the security measures are provided when the transcription is performed.

125. The system according to claim 121, wherein the receiver receives the request from at least one of: a processor in the facility, a processor of the end-user, the end-user, another trend generator, and a government vehicle registry.

126. The system according to claim 121, wherein the receiver is adapted to accept the at least one datum from a government vehicle registry.

127. The system according to claim 121, further comprising a data repository for maintaining the at least one datum stored by the sorter and permitting access thereto by the trend engine.

128. The system according to claim 127, wherein the transmitter provides the report to the end-user at at least one of: a processor in the facility a processor of the end-user, the end-user and a government vehicle registry.

129. The system according to claim 128, wherein the at least one datum comprises a vehicle datum comprising the identifier and at least one service activity datum.

130. The system according to claim 129, wherein the vehicle datum comprises at least one of: a vehicle identification number (VIN) of the vehicle, a date, a time, a mileage, a government registration identifier, information describing the vehicle, and information describing the end-user.

131. The system according to claim 130, wherein the at least one service activity datum comprises at least one of: a vehicle identification number (VIN) of the vehicle, a date, a time, a mileage, information describing the service activity and information describing a service cost of performing the service activity.

132. The system according to claim 131, wherein the range begins at a value of the parameter at an initial event that is at least one of: when the end-user obtained the vehicle, when a previous end-user of the vehicle obtained the vehicle, a beginning of a calendar year, a beginning of a fiscal year of the end-user, an initial service activity performed on the vehicle, a mileage threshold of the vehicle and a significant event of the end-user.

133. The system according to claim 132, wherein the parameter is a date and the interval is at least one of: a range of consecutive years, a year, a half-year, a quarter, a trimester and a month.

134. The system according to claim 132, wherein the parameter is an accumulated mileage and the interval is at least one of: 100,000 miles, 50,000 miles, 20,000 miles, 10,000 miles, 5,000 miles, 2,000 miles, 1,000 miles, 500 miles, 250 miles, 100 miles, 50 miles, 200,000 km, 100,000 km, 50,000 km, 20,000 km, 10,000 km, 5,000 km, 2,000 km, 1,000 km, 500 km, 250 km and 100 km.

135. The system according to claim 131, wherein the attribute extracted is at least one of: a total service cost, an average service cost, a median service cost, a number of service appointments, a number of service activities, a category of service activities, a type of service activity, a total duration of service activities, an average duration of service activities, a median duration of service activities, a number of days in a service facility, a duration of a service activities and a number of unit hours incurred in a service activity of the data in the set.

136. The system according to claim 135, wherein the service facility is at least one of: an automotive repair facility, a fuel refilling station, a car dealership, a service department of a dealership, a parts department of a dealership, a government vehicle registry and another end-user.

137. The system according to claim 136, further comprising a comparator for receiving a comparison report request, juxtaposing at least one of the trend and the ordered data against an estimate of vehicle service costs for at least one interval within the range to create a comparison report responsive thereto.

138. The system according to claim 135, further comprising a historian for receiving a history report request and listing at least a subset of all data associated with the vehicle to create a history report responsive thereto.

139. The system according to claim 136, further comprising a calculator for receiving a use category report request and allocating the data associated with the vehicle within the range to one of a plurality of use categories, based at least one use datum, each identifying a subset of the range and allocated to one of the categories to create a use category report responsive thereto.

140. The system according to claim 139, wherein the receiver accepts the use data from at least one of: a processor of the end-user and the end-user.

141. The system according to claim 136, further comprising a customer loyalty administrator for accumulating the data associated with at least one vehicle of the end-user in the range and awarding at least one entitlement under a customer loyalty program (CLP) conditioned on at least one of: the vehicle and the end-user, when at least one threshold of the CLP is exceeded by a feature of the accumulated data.

142. The system according to claim 141, wherein the feature is at least one of:
the total service cost, a number of service activities and a type of service activity of the accumulated data in the range.

143. A method for providing at least one trend of service costs of a vehicle having a unique identifier, as a function of a parameter, the method comprising:
accepting at least one datum generated at a point of sale in a service facility, from a processor in the facility in a manner devoid of transcription of information contained therein, the at least one datum comprising an actual cost of a service activity performed at the facility;
storing the at least one datum in association with the identifier and a value of the parameter;
receiving a report request from an end-user of the vehicle;
determining from the request that the at least one trend is to be provided for all data associated with the identifier, for a range of the parameter, apportioned into at least one interval;
ordering data having a value of the parameter that lies within the range, that was previously accumulated in association with the identifier, according to the value of the parameter;
dividing the ordered data into sets corresponding to successive intervals within the range, based on the value of the parameter associated with each datum thereof; and
extracting an attribute from the data in each set to create a trend report responsive to the request; and
transmitting the report for access by the end-user.

144. The method according to claim 143, wherein the parameter is at least one of: date, time and accumulated mileage,
further comprising accepting at least one transcribed datum comprising a transcription of an actual cost of a service activity performed at at least one of: the facility and another facility and storing the at least one transcribed datum,
wherein the method is performed by a trend generator and the request is received from at least one of: a processor in the facility, a processor of the end-user, the end-user, another trend generator, and a government vehicle registry,
wherein the report is provided to the end-user at at least one of: a processor in the facility a processor of the end-user, the end-user and a government vehicle registry, wherein the at least one datum comprises a vehicle datum comprising the identifier and at least one service activity datum,
wherein the vehicle datum comprises at least one of: a vehicle identification number (VIN) of the vehicle, a date, a time, a mileage, a government registration identifier, information describing the vehicle, and information describing the end-user,
wherein the at least one service activity datum comprises at least one of: a vehicle identification number (VIN) of the vehicle, a date, a time, a mileage, information describing the service activity and information describing a service cost of performing the service activity,
wherein the range begins at a value of the parameter at an initial event that is at least one of: when the end-user obtained the vehicle, when a previous end-user of the vehicle obtained the vehicle, a beginning of a calendar year, a beginning of a fiscal year of the end-user, an initial service activity performed on the vehicle, a mileage threshold of the vehicle and a significant event of the end-user,
wherein the attribute extracted is at least one of: a total service cost, an average service cost, a median service cost, a number of service appointments, a number of service activities, a category of service activities, a type of service activity, a total duration of service activities, an average duration of service activities, a median duration of service activities, a number of days in a service facility, a duration of a service activities and a number of unit hours incurred in a service activity of the data in the set, and
wherein the service facility is at least one of: an automotive repair facility, a fuel refilling station, a car dealership, a service department of a dealership, a parts department of a dealership, a government vehicle registry and another end-user.
